(19) United States
(12) Patent Application Publication
(10) Pub. No.: US 2007/0119679 A1
(43) Pub. Date: May 31, 2007

(54) Multiplate clutch device and clutch disk assembly

(75) Inventors: Yoshinobu Fukuda, Osaka (JP); Hideaki Namba, Osaka (JP)

Correspondence Address: GLOBAL IP COUNSELORS, LLP, 1233 20TH STREET, NW, SUITE 700, WASHINGTON, DC, 20036-2680, US

(73) Assignee: Exedy Corporation, Osaka (JP)

(21) Appl. No.: 10/583,998

(22) PCT Filed: Nov. 25, 2004
(86) PCT No.: PCT/JP04/17466

§ 371 Date: Jun. 22, 2006

(30) Foreign Application Priority Data
Dec. 22, 2003 (JP) 2003-425477
Apr. 23, 2004 (JP) 2004-128389

(51) Int. Cl. F16D 13/62; F16D 13/68

(52) U.S. Cl. 192/70.17; 192/70.2

(57) ABSTRACT

A multi-plate clutch device is for transmitting and cutting off, with respect to a transmission input shaft, power from an engine flywheel. The multi-plate clutch device is disposed with a clutch disk assembly and a clutch cover assembly that includes a pressure plate for pressing the clutch disk assembly towards the flywheel. The clutch disk assembly is disposed with a spline hub, a friction coupler and a damper mechanism that elastically couples together the spline hub and the friction coupler in a rotation direction. The friction coupler includes a ring member coupled to an outer peripheral side of the damper mechanism, plural first friction plates and a second friction plate disposed between plurality of first friction plates. At least one of the plural first friction plates is configured by a carbon composite material.

### TECHNICAL FIELD

The present invention relates to a multi-plate clutch device and a clutch disk assembly, and in particular to a multi-plate clutch device and a clutch disk assembly that are strengthened for high load use.

### BACKGROUND ART

Usually, a multi-plate clutch device used in racing automobiles is designed with emphasis given to use at high loads and durability. This type of multi-plate clutch device is disposed with a clutch disk assembly disposed near an engine flywheel and a clutch cover assembly that is fixed to the flywheel and includes a pressure plate for pressing the clutch disk assembly towards the flywheel. Moreover, the clutch disk assembly is disposed with an annular friction coupler at an outer peripheral side thereof, and the friction coupler is disposed with a plurality of first friction plates and a second friction plate disposed between the plurality of first friction plates. When the first and second friction plates are nipped between the flywheel and the pressure plate, torque is directly transmitted to a transmission input shaft via the clutch disk assembly (e.g., see Japanese Patent Application Publication No. 2003-90355).

The torque transmission capacity of the clutch device is determined by the urging force on the pressure plate, the diameter of the friction plates (effective radius of the clutch), the material of the friction plates (friction coefficient) and the number of friction surfaces. For example, by making the urging force or the friction coefficient larger, or by increasing the number of friction surfaces, frictional resistance becomes larger and the torque transmission capacity also becomes larger. Also, by increasing the effective radius of the clutch, the torque transmission capacity becomes larger. However, since there are structural limitations in regard to the urging force, the effective radius of the clutch and the number of friction surfaces, there is a limit on how large the torque transmission capacity can be made with these elements. On the other hand, the friction coefficient can be raised by altering the material of the friction plates, and since effects such as improvements in operability and durability can be expected by using a material where consideration is given to weight reduction and thermal resistance, friction plates of various materials have conventionally been developed.

For example, a composite material having carbon as a main component (carbon composite material) is known as a material for the friction plates of a multi-plate clutch device in racing automobiles. The friction plate formed of the carbon composite material may be generally referred to as a “carbon friction plate.” Among the characteristics of carbon composite materials, firstly, there is the characteristic that they have a large friction coefficient in comparison to conventional friction materials (e.g., friction materials including metal fibers). For this reason, when a carbon composite material having a high friction coefficient is used, frictional resistance generated by the friction surfaces becomes larger, and the torque transmission capacity also becomes larger in comparison to that of conventional friction materials. Secondly, the weight of carbon composite materials is light in comparison to that of conventional friction materials and the inertial force generated by rotational motion is smaller. Thus, it becomes easy to synchronize revolutions when shifting gears, and operability when shifting gears is improved. Moreover, since carbon composite materials have high thermal resistance and exhibit little deformation in comparison to conventional friction materials, durability is also improved. By using a carbon composite material in this manner as the friction material, it becomes possible to use a racing-use multi-plate clutch device at a high load, and durability is also improved.

### DISCLOSURE OF THE INVENTION

Although emphasis has been given to strengthening multi-plate clutch devices in racing automobiles for a high load, consideration has not been given to operability and quietness at the time of clutch engagement and release. For example, when the friction coefficient of the friction plates is high, torque is suddenly transmitted at the time of clutch engagement, whereby the width of the pedal stroke in a half-clutched state becomes extremely small, or else the life of the transmission is shortened. Also, a so-called rattling sound occurs because fluctuations in the rotation of the engine are directly transmitted to the transmission and differential.

The clutch disk assembly causes the rattling sound. More specifically, the clutch disk assembly is formed of a hub flange having a first cylindrical portion fixed to a flywheel and a second cylindrical portion arranged radially inside the first cylindrical portion, and coupled to a shaft, and drive and driven plates that are engaged with the first and second cylindrical portions and serve as friction plates, respectively. This clutch disk assembly is configured to engage the friction plate with an output member via gear meshing, and the friction plate is axially movable (see. e.g., Japanese Patent Application Publication No. 2003-90355). Since the friction plate is coupled to the output member via the gear meshing, such gears cause gear noises or rattling sound due to rotation fluctuations of an engine. The clutch disk assembly having the above structure requires a mechanism to restrict axial movement of the friction plate, which complicates the structure near a portion for fixing the friction plate.

As described above, racing-use multi-plate clutch devices have drawbacks in operability and quietness (vibration absorbency). However, these drawbacks present no problem in racing-use multi-plate clutch devices. This is because racing drivers operating the racing-use multi-plate clutch devices have a higher operation skill level than ordinary drivers, and it is hardly required in circuits to reduce noises such as the rattling sound. Further, the complication of the structure hardly causes a problem provided that it can withstand high loads for racing.

On the other hand, there are not a few people who desire passenger automobile clutch devices that are strengthened or enhanced for high load use as are racing-use multi-plate clutch devices. With a high-load specification clutch device, it becomes possible to accommodate even a high-output engine because the torque transmission capacity becomes larger, and high performance can be exhibited in various situations in comparison to conventional clutch devices for passenger automobiles. Also, since high-load clutch devices are highly durable, their parts do not have to be replaced for long periods of time, and maintenance costs can be reduced. Further, by simplifying the complicated structure, the cost of the clutch device can be lowered, and the clutch devices can be readily employed in passenger automobiles in addition to the racing automobiles.

As described above, since the advantage of disposing multi-plate clutch devices strengthened for high load use in passenger automobiles is great, there is a demand to improve their operability and quietness for use in passenger automobiles. Also, it is desired to simplify the structures near the portion for attaching the friction plate.

It is an object of the present invention to improve the operability and quietness of a multi-plate clutch device strengthened for high load use.

It is another object of the present invention to simplify structures near a friction plate attaching portion.

A multi-plate clutch device according to a first aspect of the present invention transmits and cuts off, with respect to an output rotor, power from an engine input rotor, the multi-plate clutch device including: a clutch disk assembly that is coupled to the output rotor and disposed near the input rotor; and a clutch cover assembly that is coupled to the input rotor and includes a pressure plate to press the clutch disk assembly towards the input rotor. The clutch disk assembly is disposed with a hub that is coupled to the output rotor, a friction coupler that is disposed at an outer peripheral side of the hub and is to be nipped between the input rotor and the pressure plate, and a damper mechanism that elastically couples together the hub and the friction coupler in a rotation direction. The friction coupler includes a ring member that is coupled to an outer peripheral side of the damper mechanism, a plurality of first friction plates that are disposed at an outer peripheral side of the ring member and are engaged with the ring member so as not to be relatively rotatable and to be relatively movable in an axial direction, and a second friction plate that is disposed between the plurality of first friction plates and is engaged with the clutch cover assembly so as not to be relatively rotatable and to be relatively movable in the axial direction, and at least one of the plurality of first friction plates is configured by a carbon composite material.

In this device, since the clutch disk assembly is disposed with the damper mechanism, shock and noise such as the rattling sound at the time of clutch engagement can be absorbed even if a carbon composite material with a high friction coefficient is used for the first friction plates. Therefore, the multi-plate clutch device can be strengthened for high load use, and operability and quietness can be improved. The carbon composite material is a composite material containing carbon as a main ingredient, and may be prepared, e.g., by combination of carbon and another material, or combination of carbon and carbon (carbon-carbon composite material).

A multi-plate clutch device according to a second aspect of the present invention is the device of the first aspect, wherein at least any one of the input rotor, the pressure plate and the second friction plate is configured by a carbon composite material.

In this device, the members frictionally engaging with the first friction plates are, similar to the first friction plates, configured by a carbon composite material. The friction coefficient of the carbon composite material changes due to temperature, and there is a tendency for the magnitude of those fluctuations to be large in comparison to conventional friction materials. For example, with respect to the friction coefficient when a carbon composite material and a steel material containing iron are caused to slide, when the temperature becomes higher, the friction coefficient also becomes higher, and when the temperature becomes lower, the friction coefficient also becomes lower. On the other hand, the friction coefficients of two carbon composite materials do not change much even if the temperature changes. By using carbon composite materials having such properties, various clutch characteristics can be obtained with this device. Also, since a friction coefficient that is large in comparison to those of conventional friction materials can be obtained with this device, the device can accommodate a high load.

A multi-plate clutch device according to a third aspect of the present invention is the device of the first or second aspect, wherein the hub includes a flange portion that projects outward in a radial direction around the entire periphery of the hub and a plurality of housing portions formed by part of the flange portion being cut out. The damper mechanism is disposed with a plurality of elastic members housed in the housing portions and a pair of coupler plates that are disposed so as to be relatively rotatable with respect to the flange portion in a state where the coupler plates nip the flange portion in the axial direction, with the coupler plates being disposed with window hole portions at positions corresponding to the elastic members.

In this device, since the damper mechanism is disposed with the above-described structure, a damper mechanism having various torsional rigidities can be obtained by altering the rigidity, quantity and disposition of the elastic members. Therefore, even when a carbon composite material is used for the friction material, absorption of shock and noise at the time of clutch engagement becomes possible, and operability and quietness can be more reliably improved.

A multi-plate clutch device according to a fourth aspect of the present invention is the device of any one of first to third aspects, wherein the ring member includes a plurality of outer teeth that are formed around the entire outer peripheral side of the ring member and project outward in the radial direction. The first friction plates include a plurality of inner teeth that are formed around the entire inner peripheral sides of the first friction plates and engage with the outer teeth.

Since the device includes the outer teeth and the inner teeth, the first friction plates can be engaged with the ring member so that they are not relatively rotatable and relatively movable in the axial direction. Therefore, when the plurality of first friction plates is pressed towards the input rotor, movement of the first friction plates in the axial direction becomes easy so that the state of contact of the friction surfaces is improved and power from the input rotor can be reliably transmitted to the output rotor. Also, when the pressure is released, the torque can be quickly cut off because the first friction plates can be easily separated from their partner friction material.

A multi-plate clutch device according to a fifth aspect of the present invention is the device of the fourth aspect, wherein the ring member includes projecting portions that are disposed between the plurality of first friction plates and project further outward in the radial direction from the outer teeth.

In this device, since the first friction plates and the ring member are engaged so as to be relatively movable in the axial direction, there is the potential for the damper mechanism to fall out in the axial direction. Therefore, the outer teeth include the projecting portions, whereby the relative movement of the ring member in the axial direction with respect to the first friction plates can be regulated, and the damper mechanism can be prevented from falling out.

A multi-plate clutch device according to a sixth aspect of the present invention is the device of any one of the first to fifth aspects, wherein the clutch cover assembly includes an annular clutch cover and cover members that are plurally disposed in the rotation direction and couple together the input rotor and the clutch cover. The second friction plate includes a plurality of notch portions that engage with the cover members.

In this device, since the second friction plate includes the notch portions that engage with the cover portions, the second friction plate can be engaged with the clutch cover assembly so as not to be relatively rotatable and to be relatively movable in the axial direction. Therefore, when the plurality of first friction plates are pushed towards the input rotor, movement of the second friction plate in the axial direction becomes easy, and power from the input rotor can be reliably transmitted to the output rotor.

A multi-plate clutch device according to a seventh aspect of the present invention is the device of any one of the third to sixth aspects, wherein the device further includes fixing members that fix part of the inner peripheral side of the ring member in a state where that part of the inner peripheral side of the ring member is nipped between the outer peripheral sides of the pair of coupler plates.

Conventionally, the precision of the interval between the coupler plates has not been good because a step treatment is administered to the fixing members to determine the interval between the coupler plates. With this device, the interval between the coupler plates can be determined by the axial-direction length of the ring member by nipping part of the inner peripheral side of the ring member with the coupler plates. Thus, the precision of the interval between the coupler plates can be easily raised. Also, the ring member and the coupler plates can be more reliably fixed. Therefore, it becomes possible for this device to accommodate high load use because the strength of the damper mechanism is improved. Also, the hysteresis torque is stabilized.

A multi-plate clutch device according to an eighth aspect of the present invention is the device of any one of third to seventh aspects, wherein the ring member includes a plurality of first engagement portions that project inward in the radial direction. The flange portion includes second engagement portions that project outward in the radial direction and contact with the first engagement portions when the second engagement portions rotate a predetermined relative angle.

Conventionally, there has been the potential for the fixing members to break because the fixing members have been used as flange portion stoppers. Since this device includes the first and second engagement portions, when the flange portion and the coupler plates rotate a predetermined relative angle when the damper mechanism is activated, the first and second engagement portions contact with each other so that the torque can be reliably transmitted. Therefore, it becomes possible for the device to accommodate high load use because the strength of the damper mechanism is improved in comparison to a conventional damper mechanism where the torque had been received only by the fixing members.

A multi-plate clutch device according to a ninth aspect of the present invention is the device of seventh or eighth aspect, wherein each fixing member includes a body portion having a cylindrical shape, head portions that are disposed at both ends of the body portion and have a larger outer diameter dimension than that of the body portion, and a stepped portion that is disposed between the body portion and one of the head portions has a larger outer diameter dimension than that of the body portion and a smaller outer diameter dimension than that of the head portion.

Since the body portions at the caulking sides of the fixing members are deformed by the force acting thereon at the time of caulking and have larger outer diameters, they contact with the through holes of the coupler plates. However, since the caulking force does not act on the body portions in the vicinity of the head portions at the opposite sides, slight gaps remain between the fixing members and the through holes. However, in this device, since the fixing members include the stepped portions, the gaps between the fixing members and the through holes can be reduced in advance by raising the precision of the stepped portions, and the ring member and the coupler plates can be more reliably fixed. As a result, it becomes possible for the damper mechanism to accommodate high load use.

A multi-plate clutch device according to a tenth aspect of the present invention is the device of the seventh or eighth aspect, wherein each fixing member includes a body portion having a cylindrical shape, head portions that are disposed at both ends of the body portion and have a larger outer diameter dimension than that of the body portion, and a tapered portion that is disposed between the body portion and one of the head portions and has an outer diameter dimension that gradually becomes larger from the body portion towards the head portion.

In this device, since the fixing members include the tapered portions, the gaps between the fixing members and the through holes of the coupler plates can be reduced by raising the precision of the tapered portions, and the ring member and the coupler plates can be more reliably fixed. As a result, it becomes possible for the damper mechanism to accommodate high load use.

A multi-plate clutch device according to an eleventh aspect of the present invention is the device of any one of the first to tenth aspects, wherein at least one of the input rotor, the pressure plate and the second friction plate is made of a material containing iron as a main ingredient.

In this device, since at least one of the members that are frictionally engaged with the first friction plate is made of the iron-containing material, frictional engagement occurs between the carbon composite material and the iron-containing steel material. As described above, the friction coefficient between the carbon composite material and the iron-containing steel material changes with temperature. More specifically, when sliding occurs between the carbon composite material and the iron-containing steel material, the friction coefficient rises when the temperature of the friction surfaces rises, and lowers when the temperature of the friction surfaces lowers. Thereby, this device can have various clutch characteristics. Since this device can achieve a higher friction coefficient than that of conventional friction members, the device can operate under high loads.

A multi-plate clutch device according to a twelfth aspect of the present invention is the device of any one of the first to eleventh aspects, and further includes a release device engaged with the first biasing member to deform elastically the first biasing member. The release device axially moves towards the input rotor to release the biasing force applied by the first biasing member to the pressure plate.

In this device, the release device axially moves towards the input rotor to release the biasing force, and thus to release the clutch engagement. Thereby, the device can be employed in a so-called push-type multi-plate clutch device.

A multi-plate clutch device according to a thirteenth aspect of the present invention is the device of any one of the first to eleventh aspects, and further includes a release device engaged with the first biasing member to deform axially and elastically the first biasing member. The release device axially moves away from the input rotor to release the biasing force applied by the first biasing member to the pressure plate.

In this device, the release device axially moves away from the input rotor to release the biasing force, and thus to release the clutch engagement. Thereby, the device can be employed in a so-called pull-type multi-plate clutch device.

A multi-plate clutch device according to a fourteenth aspect of the present invention is the device of any one of the first to thirteenth aspects, and further includes a second biasing member located between the input and output rotors, and having an elastic reaction force smaller than a pushing load applied to the first friction plate for power transmission.

Particularly, when the multi-plate clutch device is used in races, a partially engaged state or the like may be kept to increase the temperature of the friction members such as the first friction plate, and thereby increasing the friction coefficients thereof. However, frictional heat raises the temperature of not only the friction members but also the temperature of the peripheral members. Since the peripheral members thermally expand in an axial direction when the temperature rises, the biasing force of the first biasing member relatively increases. Consequently, such a phenomenon occurs that a clutch torque rapidly rises even when the depression degree of a clutch pedal is kept constant. Thereby, such a problem may occur that the clutch torque exceeds a braking effect to move a vehicle against driver's will, or that excessive loads are exerted on the first and second friction plates and others to cause abnormal wearing or the like when the brake stops the vehicle.

Since this device has the second biasing member having an elastic reaction force smaller than the pushing load to be applied to the first friction plate for the power transmission, the second biasing member can absorb deformation due to thermal expansion even when the frictional heat thermally expands the peripheral members in the axial direction during the partially engaged state. Thereby, the clutch torque does not rapidly rise even when the partially engaged state is maintained, and this device can prevent unintentional starting of the vehicle, and can suppress abnormal wearing of the first and second friction plates and the others.

A multi-plate clutch device according to a fifteenth aspect of the present invention is the device of the fourteenth aspect, wherein the second biasing member is arranged between the first biasing member and the pressure plate.

In this device, since the second biasing member is arranged between the first biasing member and the pressure plate, the second biasing member can absorb deformation caused by thermal expansion even when the frictional heat thermally and axially expands the pressure plate during the partially engaged state. Thereby, the clutch torque does not rapidly rise even when the partially engaged state is kept, and this device can prevent unintentional start of the vehicle, and can suppress abnormal wearing of the first and second friction plates and the others.

A multi-plate clutch device according to a sixteenth aspect of the present invention is the device of any one of the third to fifteenth aspects, and further includes an annular friction member arranged between at least one of the coupler plates and the flange portion to receive an axial load exerted between the coupler plate and the flange portion.

Since the friction member is arranged between the coupler plate and the flange portion, this device can keep a constant axial space between them even when the axial load is applied therebetween, and can prevent contact between them. Since the friction member is employed, a hysteresis torque occurs between the coupler plate and the flange portion when these members rotate relatively to each other, and therefore the device can effectively absorb torsional vibrations.

A multi-plate clutch device according to a seventeenth aspect of the present invention is the device of any one of the third to sixteenth aspects, and further includes an annular third biasing member arranged between at least one of the coupler plates and the flange portion to apply an axial biasing force to the coupler plate and the flange portion.

In this device, since the third biasing member is arranged between the coupler plate and the flange portion, the axial relative positions of the coupler plate and the flange portion can be stable. Since the flange portion can be axially biased towards the friction member, this device can further stabilize the axial relative positions of the coupler plate and the flange portion. Since the third biasing member is employed, the friction member can reliably generate the hysteresis torque, and the hysteresis torque can be adjusted according to a setting of the biasing force of the third biasing member.

A multi-plate clutch device according to an eighteenth aspect of the present invention is the device of the seventeenth aspect, wherein the third biasing member is formed of an axially and elastically deformable Belleville spring.

In this device, since the third biasing member is formed of the Belleville spring, the axial size of the space can be reduced, and a desired biasing force can be ensured.

A multi-plate clutch device according to a nineteenth aspect of the present invention is the device of the seventeenth aspect, wherein the third biasing member is formed of an axially and elastically deformable wavy spring.

In this device, since the third biasing member is formed of the Belleville spring, the axial size of the space can be reduced, and a desired biasing force can be ensured.

A clutch disk assembly according to a twentieth aspect of the present invention to transmit and to intercept a power from a flywheel on an engine side to an input shaft of a transmission, includes a friction plate made of carbon, a clutch disk body and a plurality of fixing units. The friction plate made of carbon is pressed against the flywheel. The clutch disk body has a disk-like input portion having an outer periphery coupled to an inner peripheral portion of the friction plate, and an output portion coupled to the input shaft of the transmission. A plurality of fixing units directly couples the outer peripheral portion of the disk-like input portion to the inner peripheral portion of the friction plate.

This device transmits the power of the engine to the transmission via the carbon-made friction plate and the clutch disk body. In this operation, the fixing units directly couple the carbon-made friction plate to the disk-like input portion of the clutch disk body. This simplifies a mechanism restricting an axial movement of the friction plate, and thus simplifies the structure around portions fixing the friction plate. Since gear-meshing coupling is not employed, gear noises do not occur from the coupling portion between the friction plate and the clutch disk body in contrast to the conventional structure. The “carbon-made friction plate” represents the friction plate that is formed of a carbon composite material. The carbon composite material is a composite material containing carbon as a main ingredient, and may be prepared, e.g., by combination of carbon and another material, or combination of carbon and carbon (carbon-carbon composite material).

A clutch disk assembly according to a twenty-first aspect of the present invention is the assembly of the twentieth aspect, wherein the friction plate has a recess to insert the fixing unit. The fixing unit has a flange portion, a trunk portion and a fixing portion. The flange portion is in contact with a side surface of the friction plate, and restricts the relative axial movement of the friction plate. The trunk portion is inserted into the recess of the friction plate, has a thickness corresponding to the thickness of the friction plate and has an end surface partially in contact with a side surface of the disk-like input portion. The fixing portion is formed at an end remote from the flange portion, and is fixed to the disk-like input portion.

In this device, since the fixing unit has the trunk portion, the coupling relationship between the friction plate and the clutch disk body can be adjusted by controlling the length of the trunk portion. More specifically, when the trunk portion of the fixing unit has a length equal to the thickness of the friction plate, the friction plate and the clutch disk body are unmovably and thus completely fixed together. When the trunk portion has a length longer than the thickness of the friction plate, the friction plate and the clutch disk body are fixed together with a certain degree of axial movability.

A clutch disk assembly according to a twenty-second aspect of the present invention is the assembly of the twentieth or twenty-first aspect, wherein the fixing unit is a rivet, and the fixing portion is fixed by caulking.

In this structure, since the fixing unit is the rivet, the fixing unit can be fixed readily.

A clutch disk assembly according to a twenty-third aspect of the present invention is the assembly of the twentieth aspect, wherein the friction plate has a recess to insert the fixing unit. The fixing units are formed of first and second fixing units. The first fixing unit has a trunk portion inserted into the recess of the friction plate. The second fixing unit has a shaft portion axially extending through the first fixing unit, a flange portion formed at one end of the shaft portion and axially engaging with the friction plate, and a fixing portion formed at the other end of the shaft portion and axially engaging with the disk-like input portion.

In this device, since the first fixing unit has the trunk portion, the coupling relationship between the friction plate and the clutch disk body can be adjusted by controlling the length of the trunk portion. More specifically, when the trunk portion of the first fixing unit has a length equal to the thickness of the friction plate, the friction plate and the clutch disk body are unmovably and thus completely fixed together. When the trunk portion has a length longer than the thickness of the friction plate, the friction plate and the clutch disk body are fixed together with a certain degree of axial movability. Since the trunk portion of the first fixing unit is inserted into the recess of the friction plate, the shaft portion, flange portion and fixing portion of the second fixing unit can restrict the relative rotation of the friction plate with respect to the disk-like input portion. Since the second fixing unit has the flange portion and the fixing portion, the axial relative movement between the disk-like input portion and the friction plate can be restricted.

A clutch disk assembly according to a twenty-fourth aspect of the present invention is the assembly of the twentieth aspect, wherein the friction plates are arranged in two positions on the axially opposite sides of an outer peripheral portion of the disk-like input portion, respectively, and have recesses to insert the fixing unit. The fixing units are formed of first and second fixing units. The first fixing unit has a trunk portion inserted into the recess of the friction plate. The second fixing unit has a shaft portion axially extending through the first fixing unit and the disk-like input portion, a flange portion formed on one end of the shaft portion and axially engaging with one of the friction plates, and a fixing portion formed on the other end of the shaft portion and axially engaging with the other friction plate.

In this device, since the first fixing unit has the trunk portion, the coupling relationship between the two friction plates and the clutch disk body can be adjusted by controlling the length of the trunk portion. More specifically, when the trunk portion of the first fixing unit has a length equal to the thickness of the friction plate, the friction plate and the clutch disk body are unmovably and thus completely fixed together. When the trunk portion has a length longer than the thickness of the friction plate, the friction plate and the clutch disk body are fixed together with a certain degree of axial movability. Since the trunk portion of the first fixing unit is inserted into the recess of the friction plate, the shaft portion, flange portion, and fixing portion can restrict the relative rotation of the friction plate with respect to the disk-like input portion. Since the second fixing portion has the shaft portion, flange portion, and fixing portion, the axial relative movement between the disk-like input portion and the two friction plates can be restricted.

A clutch disk assembly according to a twenty-fifth aspect of the present invention is the assembly of the twenty-third or twenty-fourth aspect, wherein the second fixing unit is a rivet, and the fixing portion is fixed by caulking.

In this structure, since the second fixing unit is the rivet, the first and second fixing units can be fixed readily.

A clutch disk assembly according to a twenty-sixth aspect of the present invention is the assembly of the twentieth aspect, wherein the friction plate has a recess to insert the fixing unit. The fixing units are formed of first and second fixing units. The first fixing unit has a trunk portion inserted into the recess of the friction plate, having a thickness corresponding to the thickness of the friction plate and having an end surface partially in contact with a side surface of the disk-like input portion, and a fixing portion fixed to the disk-like input portion. The second fixing portion has a flange portion axially engaging with the friction plate, and a coupling portion coupling the flange portion and the first fixing unit together.

In this device, since the first fixing unit has the trunk portion, the coupling relationship between the friction plate and the clutch disk body can be adjusted by controlling the length of the trunk portion. More specifically, when the trunk portion of the first fixing unit has a length equal to the thickness of the friction plate, the friction plate and the clutch disk body are unmovably and thus completely fixed together. When the trunk portion has a length longer than the thickness of the friction plate, the friction plate and the clutch disk body are fixed together with a certain degree of axial movability. Since the trunk portion of the first fixing unit is inserted into the recess of the friction plate, the shaft portion, flange portion and fixing portion can restrict the relative rotation of the friction plate with respect to the disk-like input portion. Since the first fixing unit has the fixing portion, and the second fixing unit has the flange portion and the coupling portion, the axial relative movement between the disk-like input portion and the friction plate can be restricted.

A clutch disk assembly according to a twenty-seventh aspect of the present invention is the assembly of the twentieth aspect, wherein the friction plate has a recess to insert the fixing unit. The fixing units are formed of first and second fixing units. The first fixing unit has a trunk portion inserted into the recess of the friction plate. The second fixing portion has a flange portion axially engaging with the friction plate, a coupling portion axially extending through the first fixing unit and fixing the flange portion to the first fixing unit, and a fixing portion formed at an end of the coupling portion remote from the flange portion, and coupling the first fixing unit to the disk-like input portion.

In this device, since the first fixing unit has the trunk portion, the coupling relationship between the friction plate and the clutch disk body can be adjusted by controlling the length of the trunk portion. More specifically, when the trunk portion of the first fixing unit has a length equal to the thickness of the friction plate, the friction plate and the clutch disk body are unmovably and thus completely fixed together. When the trunk portion has a length longer than the thickness of the friction plate, the friction plate and the clutch disk body are fixed together with a certain degree of axial movability. Since the trunk portion of the first fixing unit is inserted into the recess of the friction plate, the flange portion, coupling portion, and fixing portion can restrict the relative rotation of the friction plate with respect to the disk-like input portion. Further, the first and second fixing units can restrict the axial relative movement between the disk-like input portion and the friction plate.

A clutch disk assembly according to a twenty-eighth aspect of the present invention is the assembly of any one of the twenty-first to twenty-seventh aspects, wherein the trunk portion has an axial length equal to or longer than the thickness of the friction plate.

In this device, since the fixing unit has the trunk portion, the coupling relationship between the friction plate and the clutch disk body can be adjusted by controlling the length of the trunk portion. More specifically, when the trunk portion of the fixing unit has a length equal to the thickness of the friction plate, the friction plate and the clutch disk body are unmovably and thus completely fixed together. When the trunk portion has a length longer than the thickness of the friction plate, the friction plate and the clutch disk body are fixed together with a certain degree of axial movability.

A clutch disk assembly according to a twenty-ninth aspect of the present invention is the assembly of any one of the twenty-first to twenty-ninth aspects, wherein the recess of the friction plate has a pair of parallel side surfaces extending in a radial direction, and the trunk portion of the fixing unit has a pair of flat surfaces for contact with the pair of side surfaces.

In this device, the recess of the friction plate and the trunk portion of the fixing unit are not in point-contact but are in surface-contact with each other so that a contact pressure is small, and wearing can be suppressed.

A clutch disk assembly according to a thirtieth aspect of the present invention is the assembly of the twenty-ninth aspect, wherein spaces are ensured between the pair of flat surfaces formed at the trunk portion of the fixing unit and the pair of side surfaces of the recesses of the friction plate.

Since this device includes the plurality of fixing units, it is difficult to control accurately the sizes of all the fixing units and all the recesses. Accordingly, the spaces are formed between each fixing unit and the recess to facilitate manufacturing and assembly.

A clutch disk assembly according to a thirty-first aspect of the present invention is the assembly of any one of the twenty-second to thirtieth aspects, wherein the fixing unit further has an annular member arranged between the friction plate and at least one of the flange portion and the fixing portion.

In this device, since the fixing unit has the annular member, the axial relative movement of the friction plate with respect to the disk-like input portion can be reliably restricted even when the flange portion has an outer diameter smaller than the circumferential width of the recess.

A clutch disk assembly according to a thirty-second aspect of the present invention is the assembly of the thirty-first aspect, wherein the annular member has an outer diameter larger than the circumferential width of the recess of the friction plate.

In this device, since the annular portion has an outer diameter larger than the circumferential width of the recess, the axial relative movement of the friction plate with respect to the disk-like input portion can be restricted more reliably.

A clutch disk assembly according to a thirty-third aspect of the present invention is the assembly of any one of the twenty-third to thirty-second aspects, and further has an annular coupling member to couple the plurality of fixing units. The coupling member is arranged between the friction plate and the flange portion.

In this device, since the coupling member couples the fixing units, the relative positions of the plurality of fixing units can be stable. Since the coupling member is arranged between the friction plate and the flange portion, the axial relative movement of the friction plate with respect to the disk-like input portion can be restricted more reliably.

A clutch disk assembly according to a thirty-fourth aspect of the present invention is the assembly of any one of the twentieth to thirty-third aspects, wherein the clutch disk body includes a hub serving as the output portion and having a boss coupled to the input shaft of the transmission and a flange portion extending radially from the boss, and a disk-like input plate arranged on a side of the flange portion of the hub and serving as the disk-like input portion.

A clutch disk assembly according to a thirty-fifth aspect of the present invention is the assembly of the thirty-fourth aspect, wherein the disk-like plate is arranged for rotation within a predetermined angular range with respect to the flange portion of the hub. The clutch disk body further includes a damper portion circumferentially and electrically coupling the disk-like input plate and the flange portion of the hub.

In the multi-plate clutch device according to the invention, it is possible to improve the operability and the quietness of the multi-plate clutch device strengthened for high loads.

In the clutch disk assembly according to the invention, the structures around the friction plate attaching portion can be simple.

### BRIEF DESCRIPTION OF THE DRAWINGS

FIG. 1 is a longitudinal cross-sectional view of a multi-plate clutch device according to a first embodiment of the present invention.

FIG. 2 is lateral cross-sectional view of a clutch disk assembly of the multi-plate clutch device.

FIG. 3 is a cross-sectional view of a stop pin of the clutch disk assembly.

FIG. 4 is a cross-sectional view of a stop pin of the clutch disk assembly.

FIG. 5 longitudinal cross-sectional view of a push-type multi-plate clutch device.

FIG. 6 is a longitudinal cross-sectional view of a clutch disk assembly according to a second embodiment of the present invention.

FIG. 7 is a fragmentary front view of the clutch disk assembly of the second embodiment.

FIG. 8 is a structural view of structures around a fixing unit of the clutch disk assembly of the second embodiment.

FIG. 9 is a longitudinal cross-sectional view of a clutch disk assembly according to a third embodiment of the present invention.

FIG. 10 is a fragmentary front view of the clutch disk assembly of the third embodiment.

FIG. 11 is a view showing coupled portions of a friction plate and a clutch plate of the clutch disk assembly of the third embodiment.

FIG. 12 is a perspective view of a caulked rivet of the clutch disk assembly of the third embodiment.

FIG. 13 is a perspective view of the rivet alone before caulking.

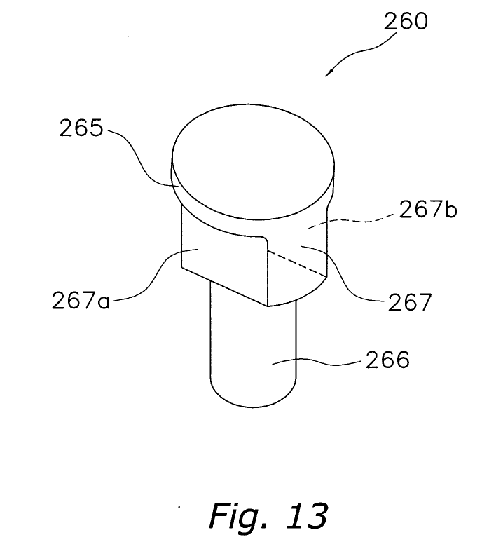

FIG. 14 is a structure view around a fixing portion according to a fourth embodiment of the present invention.

FIG. 15 a detailed view of a first fixing unit according to the fourth embodiment.

FIG. 16 is a structural view around the fixing portion according to a modification of the fourth embodiment.

FIG. 17 is a structural view around the fixing portion according to a modification of the fourth embodiment.

FIG. 18 is a detailed view of a fixing unit according to a fifth embodiment of the present invention.

FIG. 19 is a detailed view of a first fixing unit according to the fifth embodiment.

FIG. 20 is a structural view around the fixing portion according to a modification of the fourth embodiment.

FIG. 21 is a structural view around a fixing portion according to a sixth embodiment of the present invention.

FIG. 22 is a detailed view of a first fixing unit of the sixth embodiment.

FIG. 23 is a structural view around the fixing portion according to a modification of the sixth embodiment.

FIG. 24 is a view of a modification of the first fixing unit.

### BEST MODE FOR IMPLEMENTING THE INVENTION

An embodiment of the invention will be described with reference to the drawings.

### First Embodiment

1. Structure of Multi-plate Clutch Device

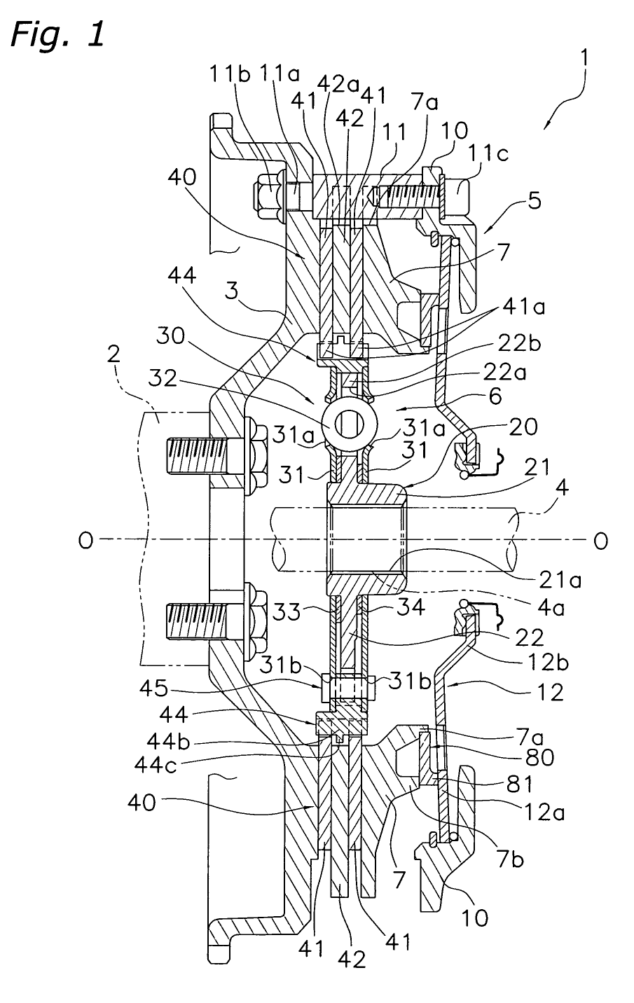

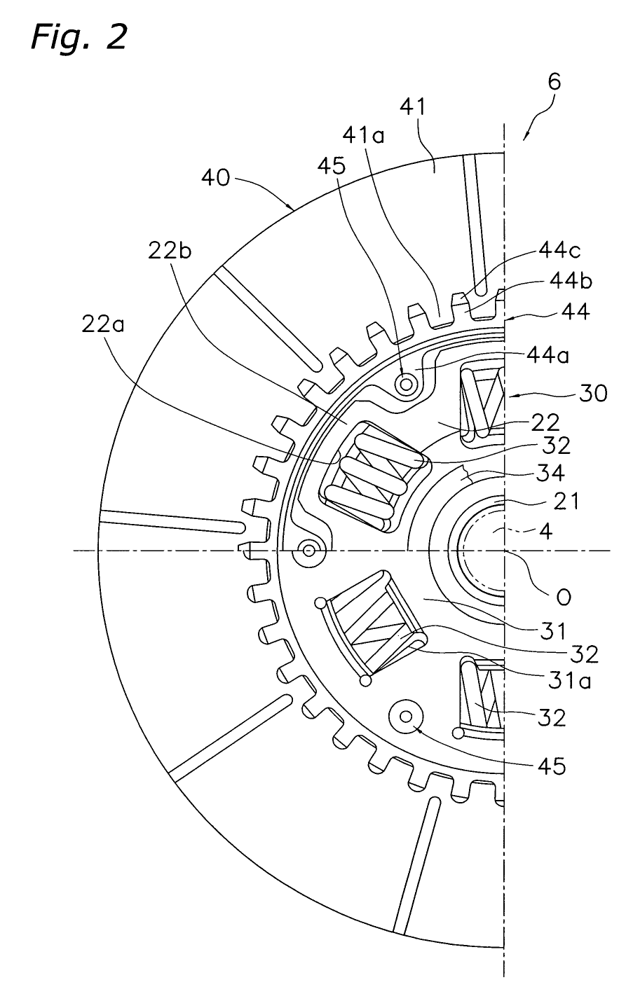

FIG. 1 is a longitudinal sectional view of a multi-plate clutch device serving as an embodiment of the invention. FIG. 2 is a horizontal sectional view of a clutch disk assembly. In the present embodiment, description will be given in regard to a pull-type dry multi-plate clutch device. A multi-plate clutch device 1 is to transmit and cut off, with respect to a transmission input shaft 4 (output rotor), power from a flywheel 3 (input rotor) coupled to an engine crankshaft 2, and is disposed between the flywheel 3 and the transmission input shaft 4. In FIG. 1, O-O represents a rotation axis line of the flywheel 3, the transmission input shaft 4 and the multi-plate clutch device 1.

The multi-plate clutch device 1 is configured mainly by a clutch cover assembly 5 and a clutch disk assembly 6. The clutch cover assembly 5 is configured by cover members 11, a clutch cover 10, a diaphragm spring 12 and a pressure plate 7. The cover members 11 are members to couple the clutch cover 10 to the flywheel 3, and are plurally disposed at an outer peripheral side of the flywheel 3. The cover members 11 include bolt portions 11a and are attached to the flywheel 3 by nuts 11b. The cover members 11 are engaged with notch portions 42a of a later-described second friction plate 42. The clutch cover 10 is an annular member and is attached to the cover members 11 with bolts 11c. In other words, the flywheel 3 and the clutch cover 10 are fixed via the cover members 11 so as not to be relatively rotatable.

The diaphragm spring 12 is to urge the pressure plate 7 in the axial direction and includes an elastic annular portion 12a and a lever portion 12b. The elastic annular portion 12a is the outer peripheral portion of the diaphragm spring 12 and is a portion that contacts with the pressure plate 7 in the axial direction. The lever portion 12b is a plurality of tongue-shaped portions extending from the annular elastic portion 12a inward in the radial direction, and an end portion thereof is coupled to an unillustrated release device. The diaphragm spring 12 is elastically deformable in the axial direction due to movement of the release device in the axial direction.

The pressure plate 7 is to press a friction coupler 40 of the later-described clutch disk assembly 6 towards the flywheel 3, and is an annular member disposed between the flywheel 3 and the clutch cover assembly 5. An annular cushioning plate 80 is arranged between the pressure plate 7 and the diaphragm spring 12. More specifically, the cushioning plate 80 is, e.g., a Belleville spring that is axially and elastically deformable, and is provided at its side near the diaphragm spring 12 with a projection 81. The cushioning plate 80 is in contact with inner and outer peripheral projections 7a and 7b of the pressure plate 7, and can be spaced from the outer peripheral projection 7b according to the axial elastic deformation of the diaphragm spring 12. The elastic reaction force of the cushioning plate 80 is smaller than the pushing load of the pressure plate 7. Therefore, even when the pressure plate 7 thermally and axially expands due to the friction heat, e.g., during the partially engaged state, the cushioning plate 80 can absorb the deformation caused by the thermal expansion. Thereby, even when the partially engaged state is held, the clutch torque does not increase suddenly, and it is possible to prevent the unintentional start of the vehicle and to suppress abnormal wearing of the friction plate and the like. The pressure plate 7 is movable in the axial direction owing to the biasing force of the diaphragm spring 12 applied via the cushioning plate 80 already described.

The clutch disk assembly 6 is to transmit and release power by frictionally engaging with the flywheel 3, and is disposed between the flywheel 3 and the pressure plate 7. Details in regard to the structure of the clutch disk assembly 6 will be described below.

2. Structure of Clutch Disk Assembly

The clutch disk assembly 6 is used in the clutch device of the automobile, and particularly in the automobile multi-plate clutch device 1, which is required to transmit a high transmission torque relative to a clutch size. The clutch disk assembly 6 is formed of a spline hub 20, a damper mechanism 30, and a frictional coupler 40. In this embodiment, the friction plate and a ring member are coupled in a gear-meshing form to be described later. The structure of each part will be described in detail below.

(1) Spline Hub

The spline hub 20 is to fix the clutch disk assembly 6 to the transmission input shaft 4, and is configured by a boss portion 21 and a flange portion 22. The boss portion 21 is a cylindrical member including a spline aperture 21a at an inner peripheral surface thereof, and is engaged with a spline portion 4a of the transmission input shaft 4 so as not to be relatively rotatable and to be relatively movable in the axial direction. The flange portion 22 is a generally discoid member that projects outward in the radial direction around the entire outer periphery of the boss portion 21. Housing portions 22a to house later-described torsion springs 32 are plurally formed in the flange portion 22. The flange portion 22 also includes, at positions corresponding to the housing portions 22a, second engagement portions 22b that project outward in the radial direction.

(2) Damper Mechanism

The damper mechanism 30 is to absorb shock and vibrations transmitted from the friction coupler 40, and is configured by the torsion springs 32, clutch and retaining plates 35 and 36 (i.e., a pair of coupler plates), a friction washer 33, and a wave or wavy spring 34. The torsion springs 32 are employed to absorb vibrations in the rotation direction between the flange portion 22 and the clutch and retaining plates 35 and 36, and are housed in the housing portions 22a of the flange portion 22 so as to be expandable and contractible in the rotation direction. In the present embodiment, six torsion springs 32 are disposed in the rotation direction.

The clutch and retaining plates 35 and 36 are a pair of annular members rotatable with respect to the spline hub 20 and are arranged on the axially opposite sides of the flange portion 22, respectively. The clutch and retaining plates 35 and 36 are provided at positions corresponding to the torsion springs 32 with window hole portions 35a and 36a each formed of a recess. The ends, in the rotation direction, of the housing portions 22a and window hole portions 35a and 36a are engaged in the rotation direction with ends of the torsion springs 22. Therefore, when the spline hub 20 rotates relatively to the clutch and retaining plates 35 and 36, the torsion springs 32 are compressed in the rotating direction. The friction washer 33 and wave spring 34 are employed to stabilize the sliding resistance (hysteresis torque) that is caused by contact of the flange portion 22 with the clutch and retaining plates 35 and 36, and each are arranged between the flange portion 22 and the clutch or retaining plate 35 or 36.

Usually, the absorption capacity of a damper mechanism is determined by the elastic coefficient, stroke, number, and radial-direction positions of the torsion springs. For example, when the elastic coefficient of the torsion springs is made larger, the torsional rigidity of the damper mechanism also becomes higher. Thus, although the damper mechanism can absorb shock at the time of clutch engagement, it cannot effectively absorb small torsional vibrations. Also, when the elastic coefficient of the torsion springs is lowered, the torsional rigidity of the damper mechanism also becomes lower. Thus, although the damper mechanism can effectively absorb small torsional vibrations such as fluctuations in the engine rotation, it cannot absorb shock at the time of clutch engagement. Therefore, it is preferable for the damper mechanism to have a low torsional rigidity and a high torsional rigidity so that it can absorb shock at the time of clutch engagement and a wide range of torsional vibrations.

Particularly when a carbon composite material is used as the friction material, as in the present embodiment, the friction coefficient becomes larger and shock at the time of clutch engagement becomes larger in comparison to what is conventionally the case. Thus, it is effective for the damper mechanism to have a low torsional rigidity and a high torsional rigidity. Therefore, the damper mechanism 30 of the present embodiment is provided with two-stage torsional rigidities.

Specifically, the housing portions 22a of the flange portion 22 are disposed at six places, similar to the torsion springs 32. The rotation-direction lengths of the housing portions 22a at three of those places are made slightly longer, and a gap is disposed between the rotation-direction ends of those housing portions 22a and the ends of the torsion springs 32. Thus, when the friction coupler 40 and the spline hub 20 relatively rotate, first, three torsion springs 32 begin to be compressed, and when the friction coupler 40 and the spline hub 20 reach a predetermined relative rotation, the remaining three torsion springs 32 also begin to be compressed. Thus, the damper mechanism 30 can easily obtain two-stage torsional rigidities with three and six torsion springs 32.

(3) Friction Coupler

The friction coupler 40 is to engage frictionally with the flywheel 3 and the pressure plate 7, and is configured by a ring member 44, stop pins 45 (fixing members), first friction plates 41 and the second friction plate 42.

1) Ring Member

The ring member 44 is to couple together the damper mechanism 30 and the first friction plates 41. The ring member 44 is an annular member disposed at the outer peripheral side of the damper mechanism 30—more specifically at the outer peripheral side of the flange portion 22—and is fixed by the stop pins 45 to the clutch and retaining plates 35 and 36 with its portion nipped therebetween.

The ring member 44 is a member to fix unrotatably the friction plate, to be described later, and the damper mechanism 30 together, and has first engagement portions 44a, outer teeth 44b, and projecting portions 44c. The first engagement portions 44a are formed of a plurality of projections projecting radially inward from the inner peripheral side of the ring member 44, respectively. The first engagement portions 44a are disposed between the second engagement portions 22b of the flange portion 22, and a space is formed in the rotation direction between the first and second engagement portions 44a and 22b. The positions of the first engagement portions 44a correspond to the positions of the stop pins 45, respectively.

The outer teeth 44b are a plurality of projections formed around the entire outer periphery of the ring member 44 and project outward in the radial direction, and are portions with which the later-described first friction plates 41 engage. The projecting portions 44c are portions that extend further outward in the radial direction from the plurality of outer teeth 44b and are disposed between the pair of first friction plates 41.

2) Stop Pins

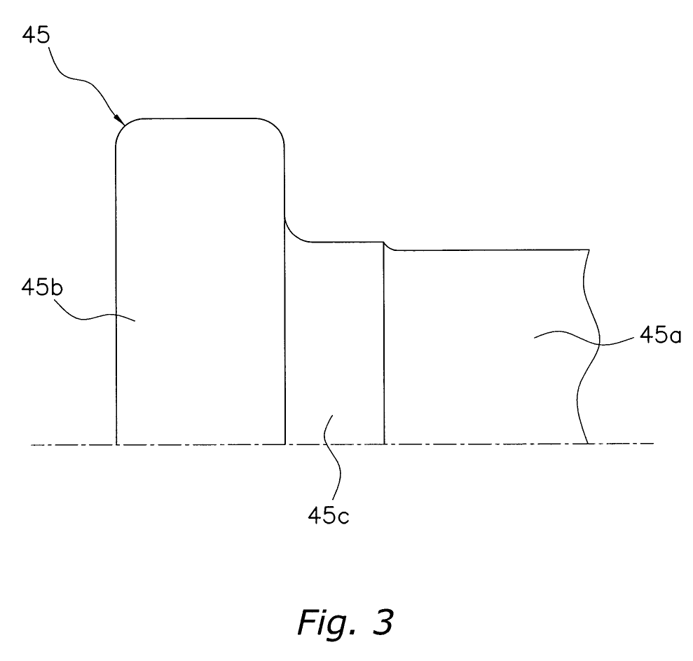

FIG. 3 is a sectional view of one of the stop pins 45. Each stop pin 45 is of a rivet type, and is formed of a trunk or body portion 45a, a head portion 45b and a stepped portion 45c. The body portion 45a is a portion that axially extends through the clutch and retaining plates 35 and 36 as well as the ring member 44, and has a cylindrical shape. The head portion 45b is a portion to tighten the clutch and retaining plates 35 and 36 to the ring member 44. The head portion 45b is disposed at each end of the body portion 45a and has a larger outer diameter than the body portion 45a. The stepped portion 45c is a portion that axially extends through holes 35b of the clutch and retaining plates 35 and 36 and is disposed between the body portion 45c and one of the head portions 45b. The stepped portion 45c has a larger outer diameter than the body portion 45a and a smaller outer diameter than the head portion 45b.

A conventional rivet is inserted into a hole of a member before forming one of its heads, and the body portion projecting away from the inserting side is caulked, whereby the head portion is formed to couple target members together. In the caulking operation, the force acts on the body portion at the caulking side to increase its outer diameter so that the outer peripheral surface of the rivet comes into contact with the inner peripheral surface of the hole. Since the stop pin 45 is provided with the stepped portion 45c, the precision of the stop pin 45c is raised, whereby the gap between the outer peripheral surface of the stop pin 45 and the inner peripheral surface of the hole 35b is reduced even at the side opposite from the caulking side, so that the joining strength is improved. Therefore, the strength of the damper mechanism 30 rises, and the damper mechanism 30 can operate for high loads.

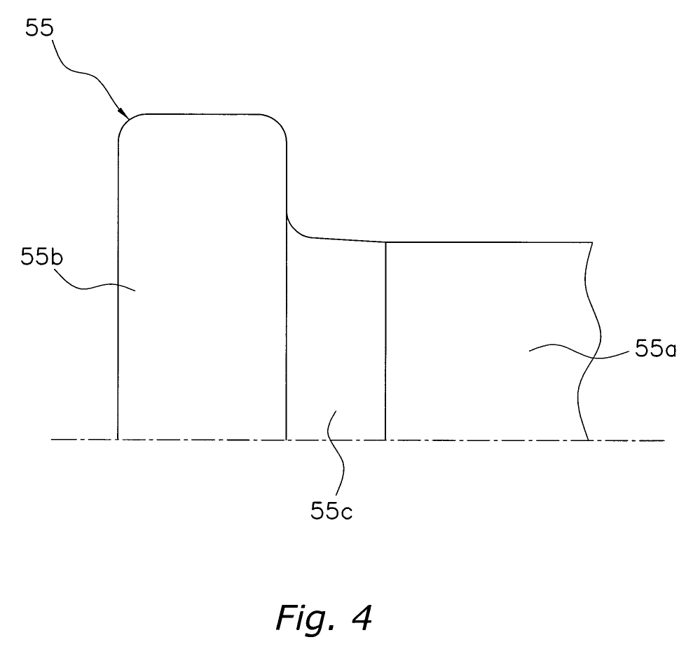

The same effect is also obtained with respect to a stop pin 55 in which the shape of the stepped portion 45c of the stop pin 45 is altered. FIG. 4 is a sectional view of the stop pin 55. With respect to the stop pin 55, the stepped portion 45c of the stop pin 45 is a tapered portion 55c whose outer diameter gradually increases as the position moves from the body portion side towards the head portion side. Thus, the joining strength is improved by increasing the precision of the tapered portion 55c, similarly to the stop pin 45 already described. Therefore, since the strength of the damper mechanism 30 is improved, the damper mechanism 30 becomes able to accommodate a high load.

3) Friction Plates

As shown in FIG. 1, the first friction plates 41 are to engage frictionally with the flywheel 3, the pressure plate 7, and the second friction plate 42, and are annular members disposed at the outer peripheral side of the damper mechanism 30. In the present embodiment, description will be given of a configuration where two first friction plates 41 are disposed in the axial direction. The first friction plates 41 include inner teeth 41a that are a plurality of projections formed around the entire inner periphery. The inner teeth 41a are engaged with the outer teeth 44b of the ring member 44, so that the first friction plates 41 and the ring member 44 are not relatively rotatable and to be relatively movable in the axial direction due to the inner teeth 41a and the outer teeth 44b.

The second friction plate 42 is to engage frictionally with the first friction plates 41, and is an annular member disposed between the pair of first friction plates 41. In the present embodiment, since there are two first friction plates 41, there is only one second friction plate 42. The second friction plate 42 includes a plurality of notch portions 42a formed around the entire outer periphery. Since the notch portions 42a are engaged with the cover members 11 of the clutch cover assembly 5, the second friction plate 42 and the clutch cover assembly 5 are engaged such that they are not relatively rotatable and to be relatively movable in the axial direction.

It should be noted that, since notch portions 7a that engage with the cover members 11 are also formed at the outer peripheral side of the pressure plate 7, the pressure plate 7 and the clutch cover assembly 5 are engaged such that they are not relatively rotatable and to be relatively movable in the axial direction.

Here, the material of the each part in the present embodiment will be described. The first and second friction plates 41 and 42, the flywheel 3, and the pressure plate 7 use a carbon composite material. The carbon composite material is a composite material containing carbon as a main ingredient, and may be prepared, e.g., by combination of carbon and another material, or combination of carbon and carbon (carbon-carbon composite material). The carbon composite material has a large friction coefficient in comparison to the friction coefficients of conventional friction materials, and among different materials, there is a tendency for the friction coefficients to fluctuate greatly due to temperature. But the friction coefficients of carbon composite materials exhibit little fluctuation resulting from temperature and are stable. Therefore, by using a carbon composite material for all of the frictionally engaging materials, a stable, high friction coefficient can be obtained, and the multi-plate clutch device 1 can be reliably strengthened for high load use.

3. Operation

Next, the operation of the multi-plate clutch device 1 will be described. In the clutch engaging operation, the release device moves axially towards the flywheel 3 according to the driver's operation on the clutch pedal, and the annular elastic portion 12a of the diaphragm spring 12 axially urges or biases the pressure plate 7 towards the flywheel 3. In this operation, the pressure plate 7 is pushed towards the friction coupler 40, the first and second friction plates 41 and 42 are nipped between the rotating pressure plate 7 and flywheel 3, and frictional resistance arises at each contact surface. Thus, the torque inputted to the flywheel 3 is transmitted to the first friction plates 41, the ring member 44, and the clutch and retaining plates 35 and 36.

When the clutch and retaining plates 35 and 36 rotate according to the inputted torque, they rotate relatively to the stopped spline hub 20. As mentioned previously, since the circumferential lengths of three of the housing portions 22a of the flange portion 22 are made longer, first, three of the torsion springs 32 are compressed between the rotation-direction ends of the window hole portions 35a and 35b and the housing portions 22a. Thus, the multi-plate clutch device 1 can absorb small torsional vibrations at the time of clutch engagement.

Also, when the clutch and retaining plates 35 and 36 further rotate relatively to the spline hub 20, the remaining three torsion springs 32 are compressed between the rotation-direction ends of the window hole portions 35a and 35b and the housing portions 22a. Thus, since all six torsion springs 32 are compressed, the multi-plate clutch device 1 can absorb shock and large torsional vibrations at the time of clutch engagement.

When the clutch and retaining plates 35 and 36 and the spline hub 20 further relatively rotate, the first engagement portions 44a of the ring member 44 and the second engagement portions 22b of the flange portion 22 contact with each other, whereby the engine torque is directly transmitted to the transmission input shaft 4 and the clutch engagement operation of the multi-plate clutch device 1 is completed. The clutch release operation is conducted by operating the pedal to move the release device in the axial direction towards the transmission.

By giving two-stage torsional rigidities to the damper mechanism 30 in this manner, shock and vibrations at the time of clutch engagement can be effectively absorbed. Thus, even with respect to the multi-plate clutch device 1 using a carbon composite material with a high friction coefficient, where operating the clutch at the time of clutch engagement is difficult, the operation becomes easy and operability is improved.

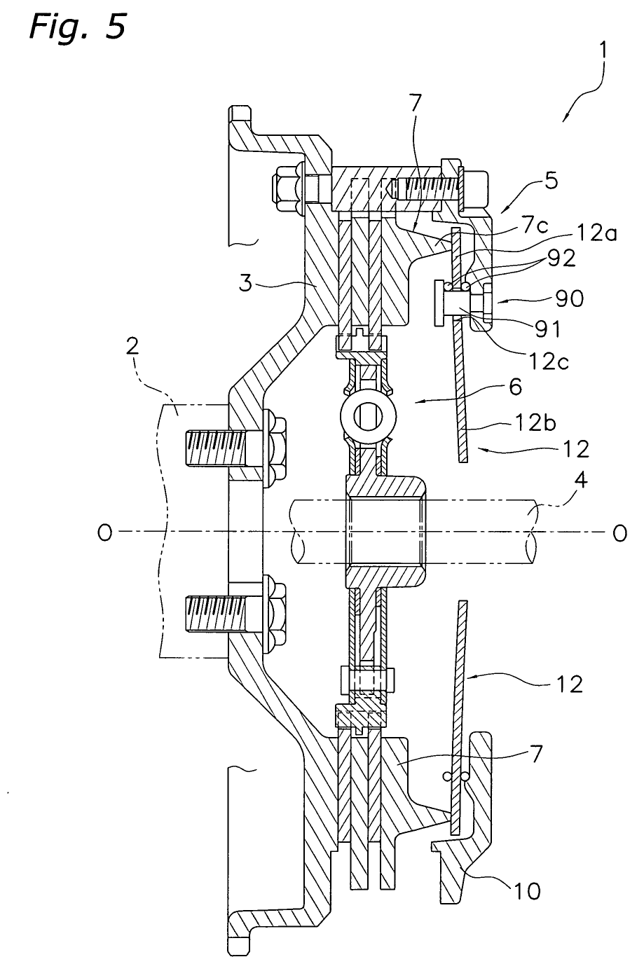

Also, in a case where fluctuations in the engine rotation arise when traveling at a constant speed after clutch engagement, the fluctuations in rotation are not directly transmitted to the transmission and differential due to the expansion and compression of the torsion springs 32. Thus, the rattling sound from the gear portions can be suppressed and quietness is improved. Although a pull type device has been described as the embodiment, the device may be of a push type as shown in FIG. 5.

### Second Embodiment

In the foregoing embodiment, the damper mechanism 30 improves the quietness of the multi-plate clutch device 1, and the following embodiment can further suppress generation of gear noises.

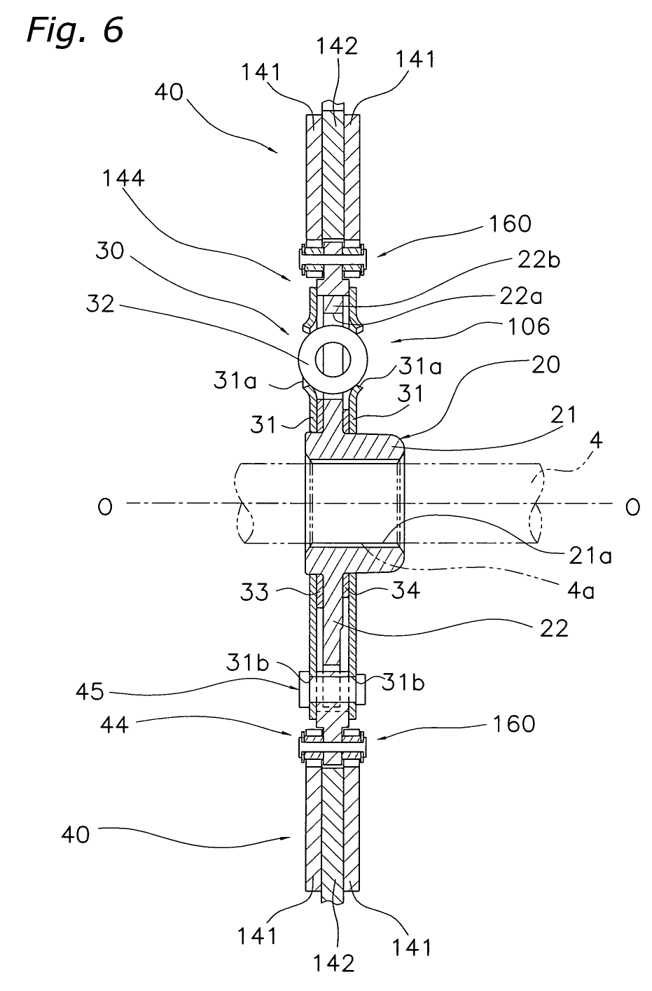

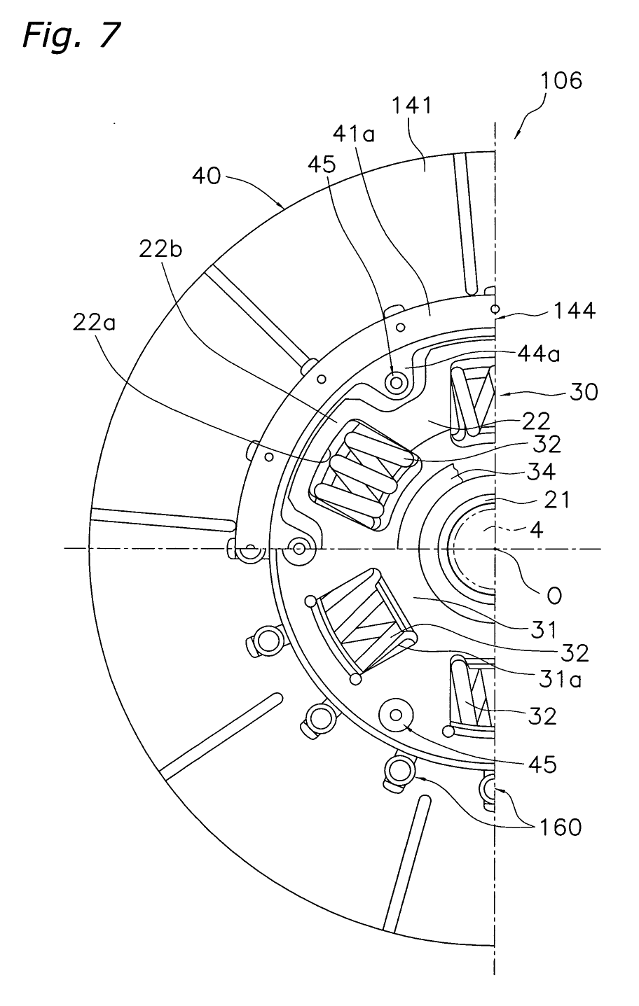

1. Clutch Disk Assembly FIGS. 6 and 7 show a clutch disk assembly 106 employing this embodiment. This clutch disk assembly 106 is used in the multi-plate clutch device 1 to transmit a torque from a flywheel (not shown) on the engine side to a transmission input shaft (not shown). In FIGS. 6 and 7, O-O represents a rotation axis line of the clutch disk assembly 106.

The clutch disk assembly 106 has a distinctive feature in portions coupling first friction plates 141 and a ring member 144 as shown in FIGS. 6 and 7. More specifically, the first friction plates 141 of the clutch disk assembly 106 are directly coupled by a fixing unit 160 to the ring member 144 while restricting the relative rotation and the axial relative movement between them.

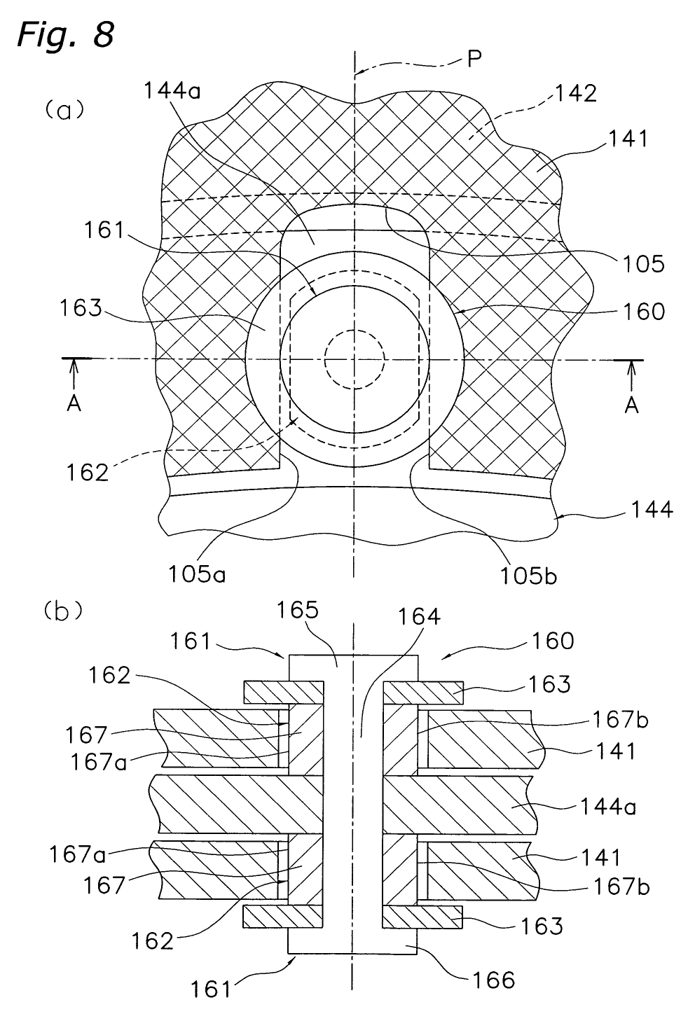

FIG. 8 is a structural view of structures around the fixing unit 160. The first friction plate 141 is provided at its inner periphery with a plurality of recesses 105 that are circumferentially and equally spaced from each other by a predetermined distance as shown in FIG. 8. As shown in FIG. 8, the recess 105 extends radially outward from the inner periphery, and has a predetermined depth and a predetermined width. A pair of side surfaces 105a and 105b of the recess 105 are parallel to a radial line P. The ring member 144 is provided throughout its circumference with an outer peripheral fixing portion 144a of a disk-like form. The two friction plates 141 hold the outer peripheral fixing portions 144a between the inner peripheral portions thereof. A second friction plate 142 is arranged radially outside the outer peripheral fixing portions 144a.

2. Fixing Unit

The fixing unit 160 is formed of first and second fixing units 161 and 162 as well as a washer 163. The first fixing units 161 are paired, and are arranged on the axially opposite sides of the outer peripheral fixing portions 144a, respectively. The first fixing unit 161 has a substantially cylindrical trunk portion 167 inserted into the recess 105 of the first friction plate 141. The second fixing unit 162 is a rivet, and is formed of a shaft portion 164, a flange portion 165, and a fixing portion 166. The shaft portion 164 axially extends through the first fixing units 161 and the outer peripheral fixing portion 144a. The flange portion 165 is formed on one end of the shaft portion 164. The fixing portion 166 is formed on the other end of the shaft portion 164. The flange portion 165 and the fixing portion 166 have larger diameters than the shaft portion 164. Each of the washers 163 has a larger diameter than the flange portion 165 and the fixing portion 166, and is held between the trunk portion 167 and the flange portion 165 or the fixing portion 166. The fixing portion 166 is located on the caulking side of the rivet, and therefore is finally caulked to fix the trunk portion 167 and the washer 163 to the outer peripheral fixing portion 144a. Thereby, the first friction plate 141 is coupled to the damper mechanism 30 via the ring member 144.

Relationships in size between the members are as follows. A width of the trunk portion 167 (i.e., a length between a pair of flat surfaces 167a and 167b) of the first fixing unit 161 is smaller than the circumferential width of the recess 105 of the first friction plate 141, and is inserted into the recess 105 with a predetermined space therebetween. The flat surfaces 167a and 167b are parallel to each other. Thereby, the recess 105 and the trunk portion 167 of the first fixing unit 161 are not in point-contact, but are in plane-contact with each other so that the contact pressure can be small, and wearing of the first friction plate 141 can be suppressed. Since spaces are ensured between the flat surfaces 167a and 167b and the side surfaces 105a and 105b, this structure facilitates the size management, manufacturing, and assembling of the plurality of first fixing units 161 and the recesses 105.

The trunk portion 167 has a length longer than the thickness of the first friction plate 141, and the first friction plate 141 is fixed to the ring member 144 with flexibility in the axial movement. In this case, the first friction plate 141 is made of carbon, and the fixing unit 160 and a clutch plate 135 are made of iron-containing materials so that there is a difference in thermal expansion coefficient, and the above structure is effective in such a case that the influence of the thermal expansion cannot be ignored at a high temperature. Since the first friction plate 141 and the ring member 144 are coupled together with flexibility in axial movement, this structure can easily release the frictional engagement of the first and second friction plates 141 and 142 in the clutch releasing operation. The carbon-made friction plate is a friction plate made of carbon composite material. The carbon composite material is a composite material containing carbon as a main ingredient, and may be prepared, e.g., by combination of carbon and another material, or combination of carbon and carbon (carbon-carbon composite material).

The outer peripheral fixing portion 144a has a thickness smaller than the thickness of the second friction plate 142. In the clutch engaging operation, the outer peripheral fixing portion 144a does not impede the frictional engagement of the first and second friction plates 141 and 142 when the two first friction plates 141 are held between the flywheel (not shown) and the pressure plate (not shown).

The flange portion 165 and the fixing portion 166 have diameters that are nearly equal to or smaller than that of the trunk portion 167. The washer 163 having a larger diameter than the flange portion 165 and fixing portion 166 is arranged between the first friction plate 141 and each of these portions 165 and 166. The washer 163 has a larger diameter than the circumferential width of the recess 105. Thereby, the axial relative movement of the first friction plates 141 is reliably restricted without increasing the outer diameters of the flange portion 165 and the fixing portion 166.

In the embodiment already described, since the fixing unit 160 directly couples the first friction plates 141, this structure simplifies the mechanism to restrict the axial movement of the first friction plates 141, and thus simplifies the structures around the attaching portion of the first friction plates 141. Since the gear meshing is not used for the coupling, this structure can further reduce the gear noises of the coupling portions of the first friction plates 141 and the ring member 144 when compared with a conventional device.

### Third Embodiment

The foregoing second embodiment has been described in connection with the multi-plate clutch device 1 in which the friction plates are formed of the pair of first friction plates 141 and the second friction plate 142. However, the invention may be applied to a single-plate clutch device as described below.

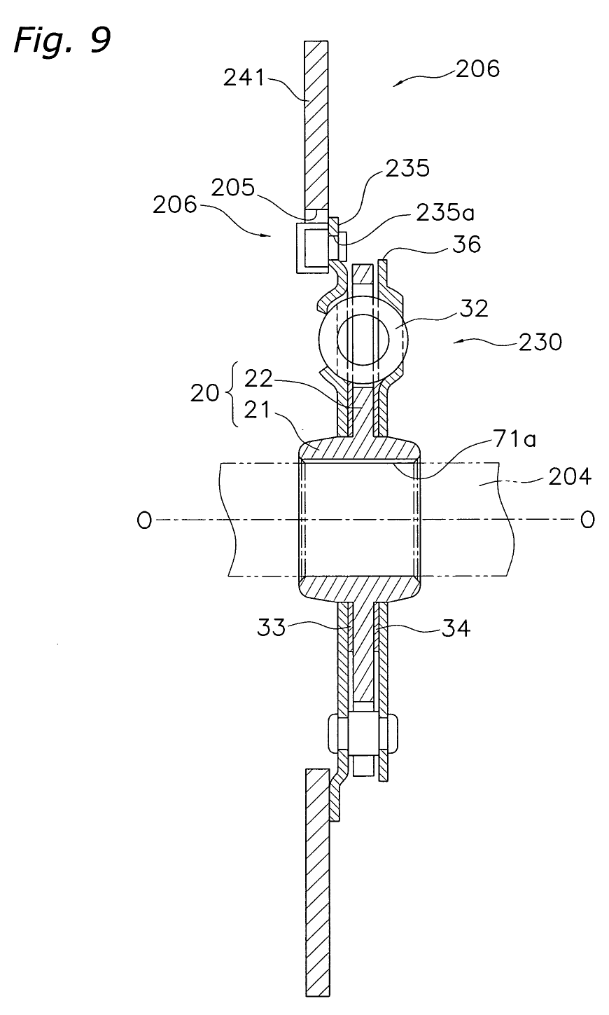

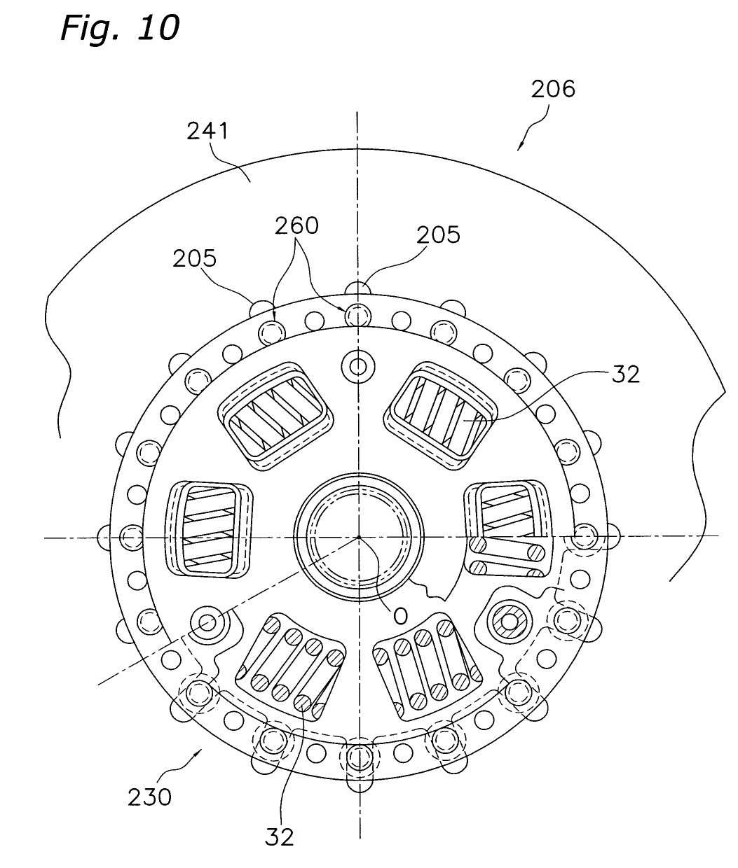

FIGS. 9 and 10 show a clutch disk assembly 206 employing the third embodiment. In FIGS. 9 and 10, O-O represents a rotation axis line of the clutch disk assembly 206.

The clutch disk assembly 206 primarily has a carbon-made friction plate 241 to be pressed against the flywheel of the engine, a damper mechanism 230 fixed to the friction plate 241, and fixing units 260 coupling the friction plate 241 and the damper mechanism 230 together. Structures around the fixing unit 260 are similar to those of the foregoing embodiments, and therefore will not be described below. The carbon-made friction plate is the friction plate made of the carbon composite material. The carbon composite material is a composite material containing carbon as a main ingredient, and may be prepared, e.g., by a combination of carbon and another material, or a combination of carbon and carbon (carbon-carbon composite material).

The fixing unit 260 is formed of a rivet. More specifically, the fixing unit 260 is inserted into a recess 205 of the friction plate 241 and an aperture 235a of a clutch plate 235 to couple directly the friction plate 241 to the outer periphery of the clutch plate 235.

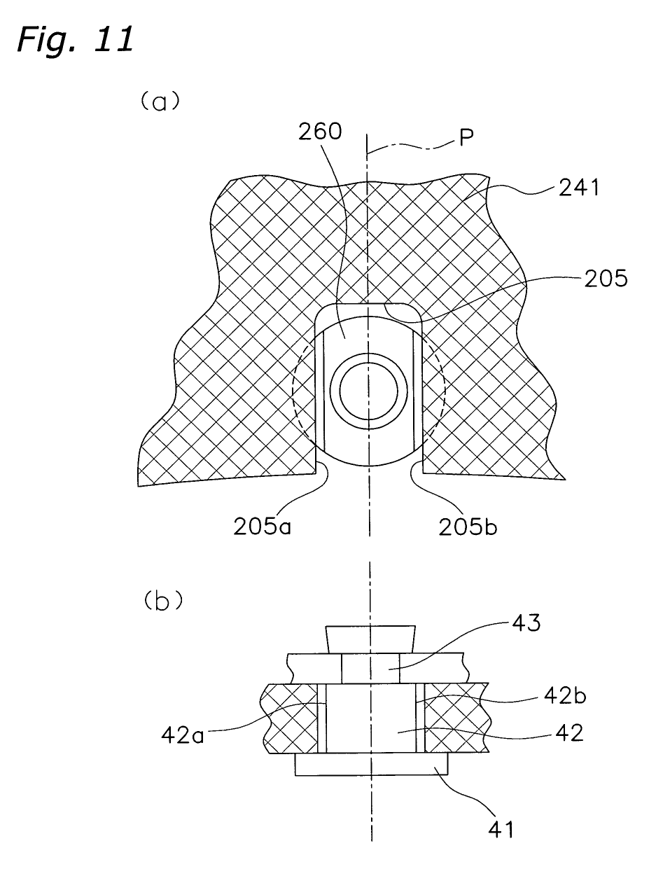

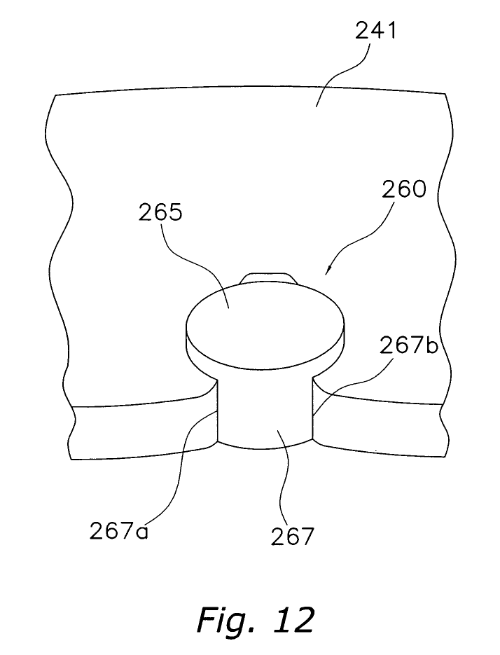

FIGS. 11 and 12 show the fixing unit 260 in the assembled state, and FIG. 12 shows the fixing unit 260 before the assembly (caulking). As shown in these figures, the fixing unit 260 has a flange portion 265, a trunk portion 267, and a fixing portion 266.

The flange portion 265 has a larger diameter than those of the other portions, and the surface near the trunk portion 267 is in contact with the side surface of the friction plate 241. The flange portion 265 projects towards the flywheel beyond the friction surface of the friction plate 241, and is located radially inside the radially inner end of the flywheel.

The trunk portion 267 is formed by forming a pair of opposed flat surfaces 267a and 267b located partially at a portion that extends continuously from the flange portion 265 and has the same diameter as the flange portion 265. The trunk portion 267 has a width (length between the paired flat surfaces 267a and 267b) that is smaller than the width of the recess 205 of the friction plate 241, and is inserted into the recess 205 with a predetermined space therebetween. In contrast to the second embodiment, the trunk portion 267 may have a length substantially equal to the thickness of the friction plate 241, and may also have a length longer than the thickness of the friction plate 241. When the trunk portion 267 has a length substantially equal to the thickness of the friction plate 241, the friction plate 241 is unmovably and thus completely fixed to the clutch plate 235. When the trunk portion 267 has a length longer than the thickness of the friction plate 241, they are fixed together with a certain degree of axial movability. In this case, the friction plate 241 is made of carbon, and the fixing unit 260 and the clutch plate 235 are made of iron-containing materials so that there is a difference in the thermal expansion coefficient, and the above structure is effective in such a case that the influence of the thermal expansion cannot be ignored at a high temperature.

The fixing portion 266 has a smaller diameter than the trunk portion 267, and is inserted into the aperture 235a of the clutch plate 235. By caulking the end of this fixing portion 266, the friction plate 241 and the clutch plate 235 are fixed together to restrict the axial movement of the friction plate 241.

### Fourth Embodiment

In the third embodiment already described, the fixing unit 260 is formed of the rivet, but the following embodiment may be employed.

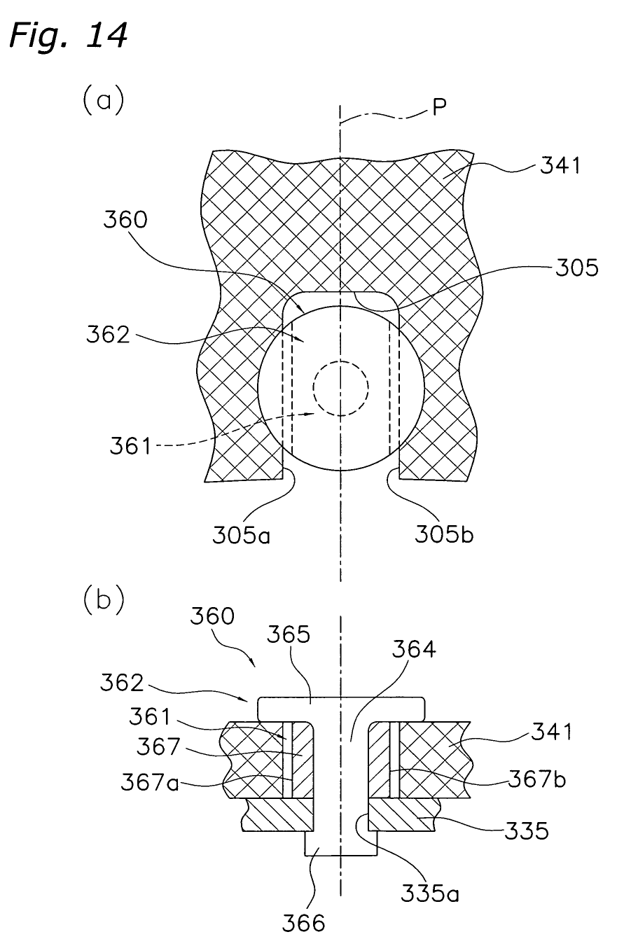

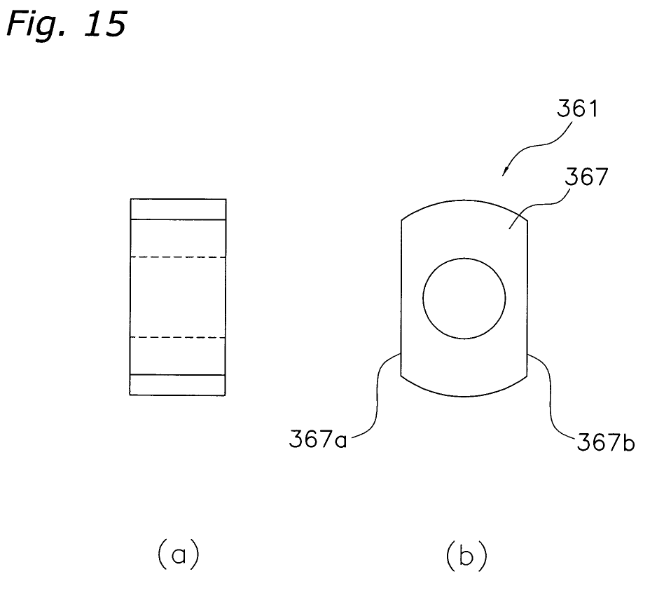

FIG. 14 shows structures around a fixing unit 360 of this embodiment. This fixing unit 360 is formed of first and second fixing units 361 and 362. FIG. 15 specifically shows the first fixing unit 361. The first fixing unit 361 has a substantially cylindrical trunk portion 367 is inserted into a recess 305 of a friction plate 341. The trunk portion 367 is provided with flat surfaces 365a and 365b corresponding to side surfaces 305a and 305b of the recess 305, respectively. The first fixing unit 361 is fixed to a clutch plate 335 by the second fixing unit 362 as shown in FIG. 14. The second fixing unit 362 is a rivet, and is formed of a shaft portion 364 extending through the first fixing unit 361 as well as a flange portion 365 and a fixing portion 366 that are formed on opposite ends of the shaft portion 364, respectively.

The flange portion 365 has an outer diameter larger than the circumferential width of the recess 305, and a surface thereof near the trunk portion 367 is in contact with the side surface of the friction plate 341. The fixing portion 366 has a smaller diameter than the trunk portion 367, and is inserted into an aperture 335a of the clutch plate 335. By caulking the end of the fixing unit 366, the first fixing unit 361 is fixed to the clutch plate 335. Since the length of the trunk portion 367 can be set according to the thickness of the friction plate 341 similar to the third embodiment, the friction plate 341 can be fixed axially movably or axially unmovably to the clutch plate 335 by adjusting the length of the trunk portion 367. The fixing unit 360 described above can achieve an effect similar to that of the third embodiment.

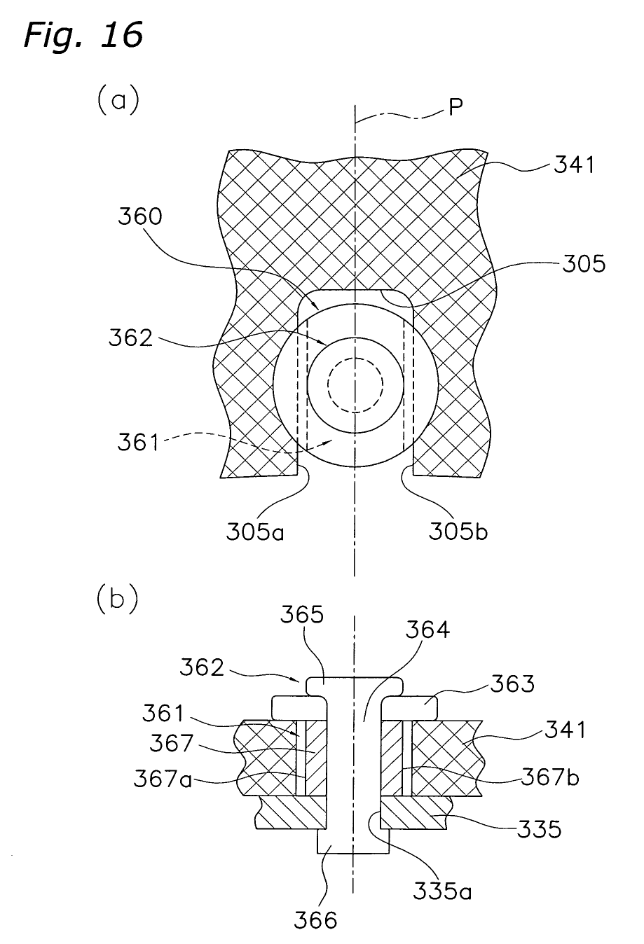

As shown in FIG. 16, a washer 363 may be arranged between the flange portion 365 and the friction plate 341. This structure can allow for the reduction of the diameter of the flange portion 365.

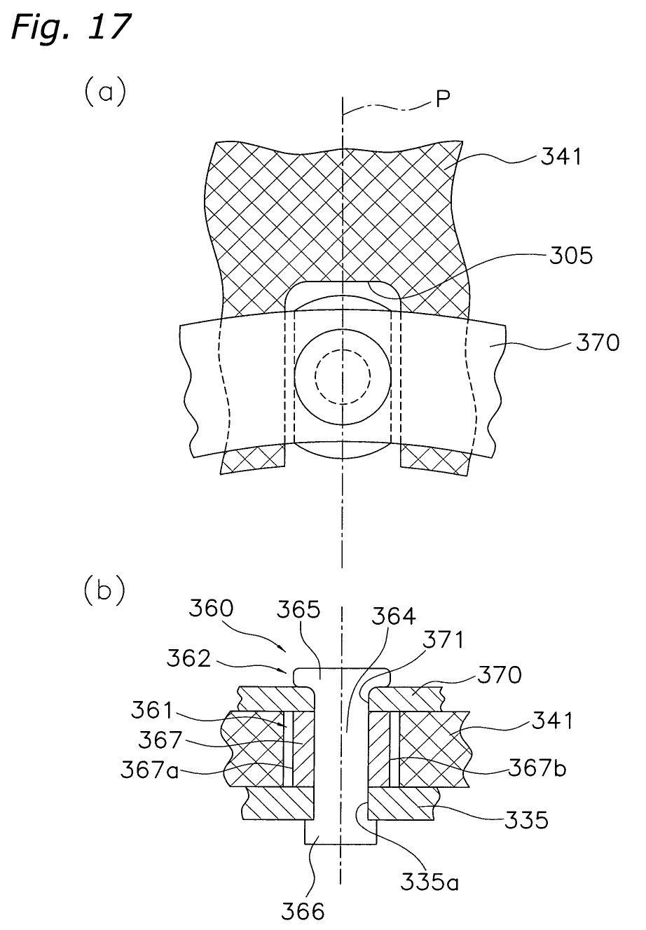

Further, the washer 363 may be replaced with a coupling member 370 as shown in FIG. 17. More specifically, the coupling member 370 has an annular form, and is employed to couple the plurality of circumferentially spaced fixing units 360. The coupling member 370 has coupling apertures 371 at positions corresponding to the fixing units 360, respectively, and the shaft portion 364 of the second fixing unit 362 extends through the coupling aperture 371. The coupling member 370 is held between the trunk portion 367 and the flange portion 365. This structure can stabilize the relative positions of the plurality of fixing units 360, and can reliably restrict the axial relative movement of the friction plate 341 with respect to the clutch plate 335 without employing a washer having a large outer diameter.

### Fifth Embodiment

In the fourth embodiment already described, the second fixing unit 362 is formed of a rivet. However, the following embodiment may be employed.

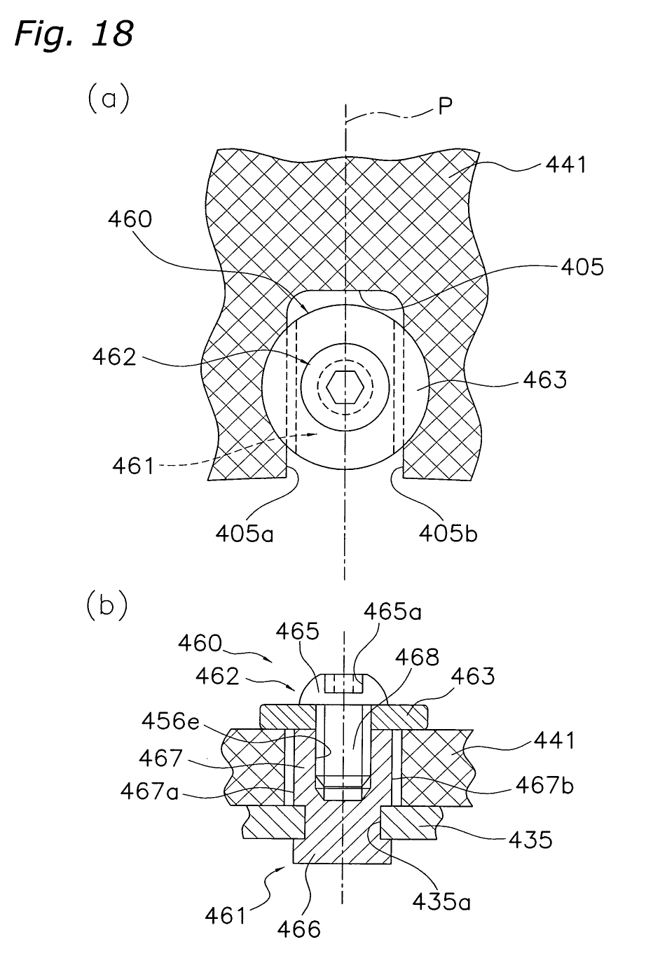

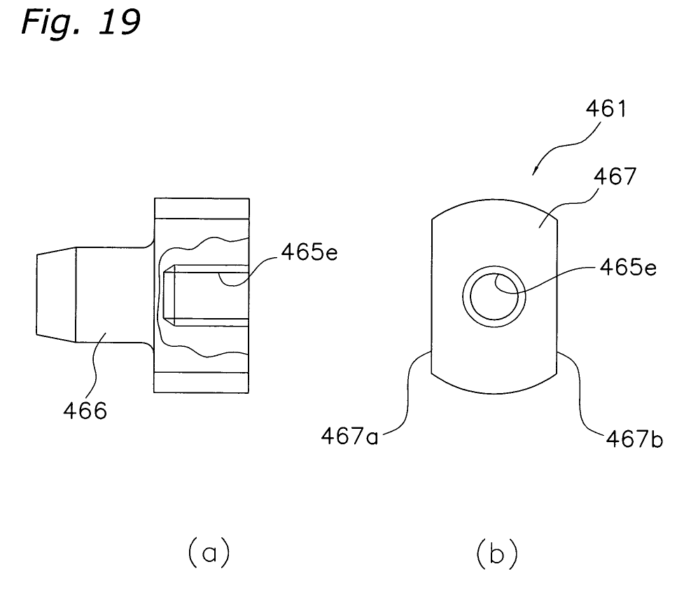

FIG. 18 shows a fixing unit 460 of this embodiment. The fixing unit 460 is formed of first and second fixing units 461 and 462 as well as a washer 463. FIG. 19 specifically shows the first fixing unit 461. The first fixing unit 461 partially has a structure of a rivet, and has a substantially cylindrical trunk portion 467 inserted into a recess 405 of a friction plate 441, and a fixing portion 466 formed at one end of the trunk portion 467. The trunk portion 467 is provided with flat surfaces 467a and 467b corresponding to side surfaces 405a and 405b of the recess 405, respectively. The fixing portion 466 has a smaller diameter than the trunk portion 467, and is inserted into an aperture 435a of a clutch plate 435. FIG. 19 shows the fixing portion 466 before caulking. By caulking the end of the fixing portion 466, the trunk portion 467 is fixed to the clutch plate 435 as shown in FIG. 18.

The second fixing unit 462 is a so-called screw, and has a flange portion 465 and a coupling portion 468. The flange portion 465 has a diameter substantially equal to that of the trunk portion 467, and is provided with an aperture 465a to screw the second fixing unit 462 into the first fixing unit by a tool. In this embodiment, the aperture 465a is hexagonal. The coupling portion 468 is a portion to couple the first fixing unit 461 to the flange portion 465, and is engaged with a threaded aperture 465e. An annular washer 463 is held between the trunk portion 467 and the flange portion 465. The washer 463 has an outer diameter larger than the circumferential width of the recess 405. The fixing unit 460 described above can achieve the effect similar to those of the third and fourth embodiments.

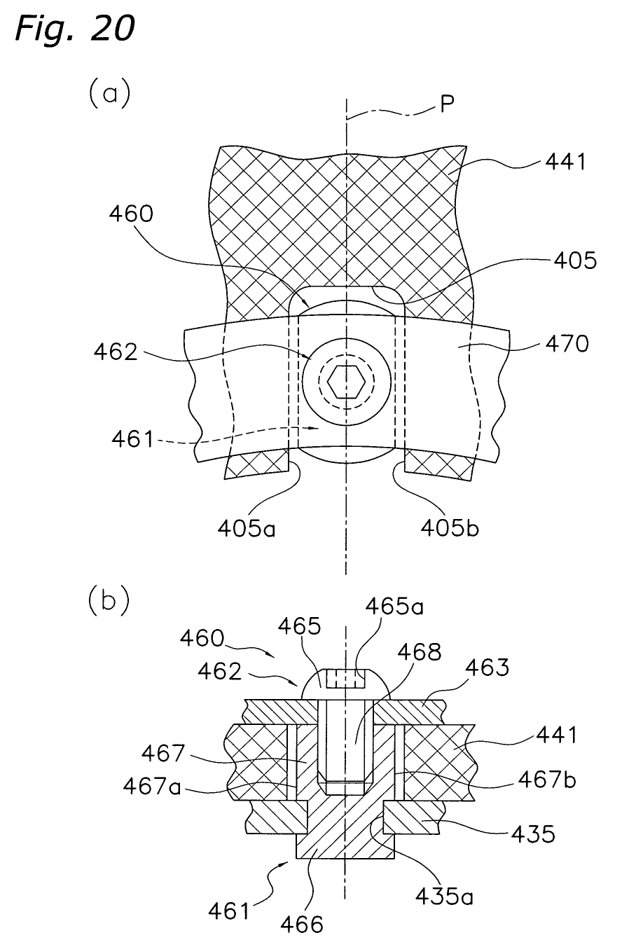

Further, as shown in FIG. 20, the washer 463 may be replaced with a coupling member 470 similarly to the fourth embodiment. Thereby, the relative positions between the fixing units 460 can be stable, and the axial relative movement of the friction plate 441 with respect to the clutch plate 435 can be reliably restricted without employing a washer of a large diameter.

### Sixth Embodiment

In the fifth embodiment already described, the first fixing unit 461 is formed of a rivet. However, the following embodiment may be employed.

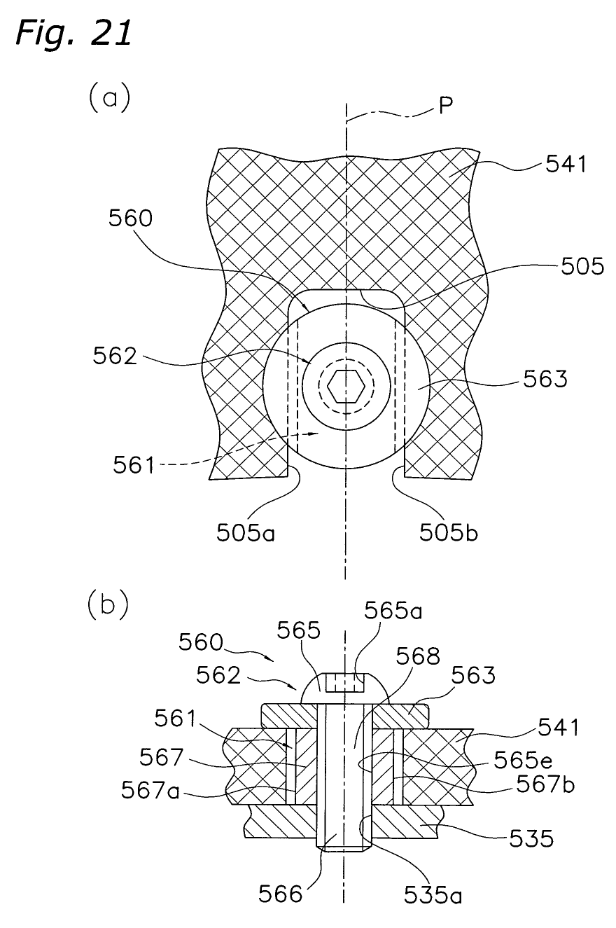

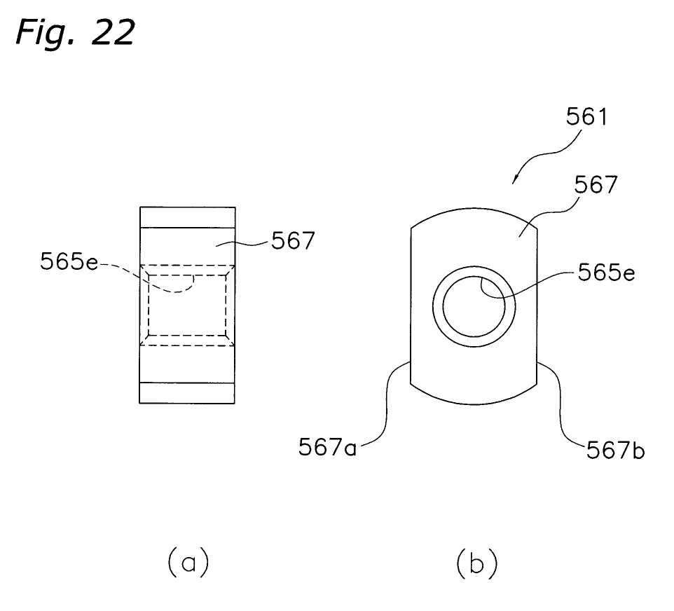

FIG. 21 shows a fixing unit 560 of this embodiment. The fixing unit 560 is formed of first and second fixing units 561 and 562 as well as a washer 563. FIG. 22 specifically shows the first fixing unit 561. The first fixing unit 561 has a substantially cylindrical trunk portion 567 inserted into a recess 505 of a friction plate 541. The trunk portion 567 is provided with flat surfaces 567a and 567b corresponding to side surfaces 505a and 505b of the recess 505, respectively.

The second fixing unit 562 is a so-called screw, and has a flange portion 565, a coupling portion 568, and a fixing portion 566. The flange portion 565 has a diameter similar to that of the trunk portion 567, and is provided with an aperture 565a to screw the second fixing unit 562 into the aperture 565a. In this embodiment, the aperture 565a is hexagonal. Each of the coupling portion 568 and the fixing portion 566 is provided at its outer peripheral side with a thread. The coupling portion 568 is employed to couple the first fixing unit 561 to the flange portion 565, and is screwed into a screw aperture 567e in the trunk portion 567. The fixing portion 566 is employed to fix a clutch plate 535 and the trunk portion 567 together, and is screwed into the aperture 535a in the clutch plate 535. An annular washer 533 is held between the trunk portion 567 and the flange portion 565. The washer 563 has an outer diameter longer than the circumferential width of the recess 505. The fixing unit 560 already described can achieve an effect similar to those of the third to fifth embodiments.

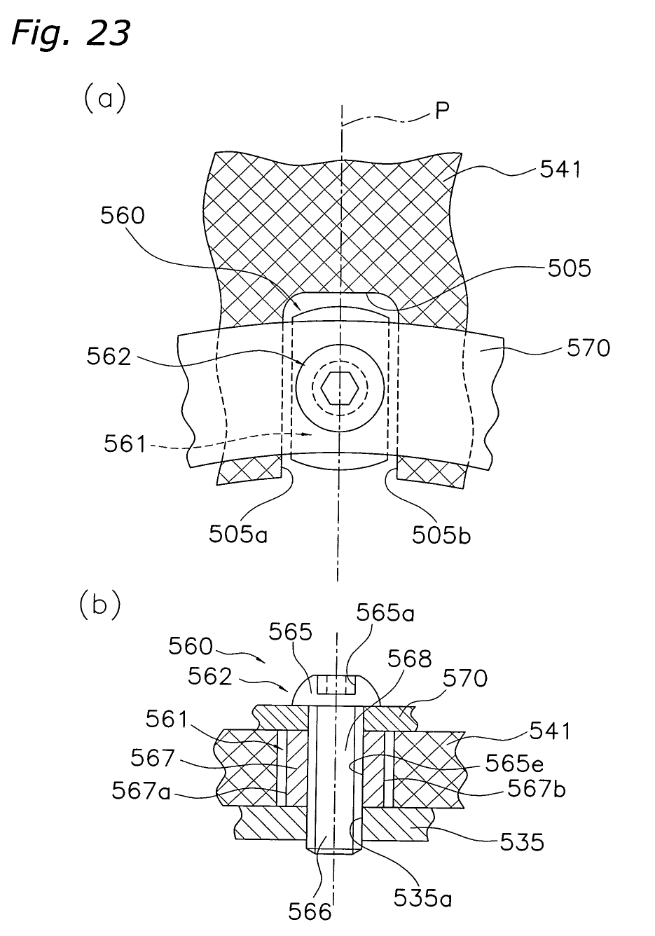

Further, as shown in FIG. 23, the washer 563 may be replaced with a coupling member 570 similarly to the fourth and fifth embodiments. Thereby, the relative positions between the fixing units 560 can be stable, and the axial relative movement of the friction plate 541 with respect to the clutch plate 535 can be reliably restricted without employing a washer having a large diameter.

### Other Embodiments

1. Type of Multi-plate Clutch Device Although the embodiments have been described in connection with the dry clutch devices, the invention is not restricted to them.

2. Damper Mechanism

In the embodiments already described, torsional characteristics of the damper mechanism have two stages. However, the characteristics may have only a single stage or multiple stages, and the foregoing embodiments are not restrictive. Although the flange portion 22 has the housing portions 22a having two kinds of circumferential lengths to achieve the two stage in the torsional characteristics. However, the clutch and retaining plates 35 and 36 may have the window hole portions 35a and 36a having two kinds of circumferential lengths, whereby similar operations and effects can be achieved.

3. Friction Material

In the first embodiment already described, the flywheel 3, pressure plate 7, and second friction plate 42 are made of the carbon composite material, these may be made of a steel material or the like. As already described, the carbon composite material and other materials (e.g., steel material) have the friction coefficients that change with temperature. The friction coefficient increases with rising of the temperature, and decreases with lowering of the temperature. Accordingly, when a passenger automobile employing the device runs in a town, the temperature rises only to a limited extent, and the friction coefficient becomes similar to those of conventional friction materials. However, when a driver intentionally causes friction by increasing the rotation speed of the engine during a partially engaged state, the frictional heat generating on the friction surfaces raises the temperature to increase the friction coefficient. Consequently, the torque transmission capacity increases when compared with a low temperature case, and therefore high loads and high durability can be achieved similar to the multi-plate clutch devices for racing use. Even when sliding occurs between the friction surfaces due to an excessive torque of the engine, the friction coefficient and thus the torque transmission capacity increase so that the sliding between the friction surfaces will stop to recover the torque transmission.

4. Form of First Fixing Unit

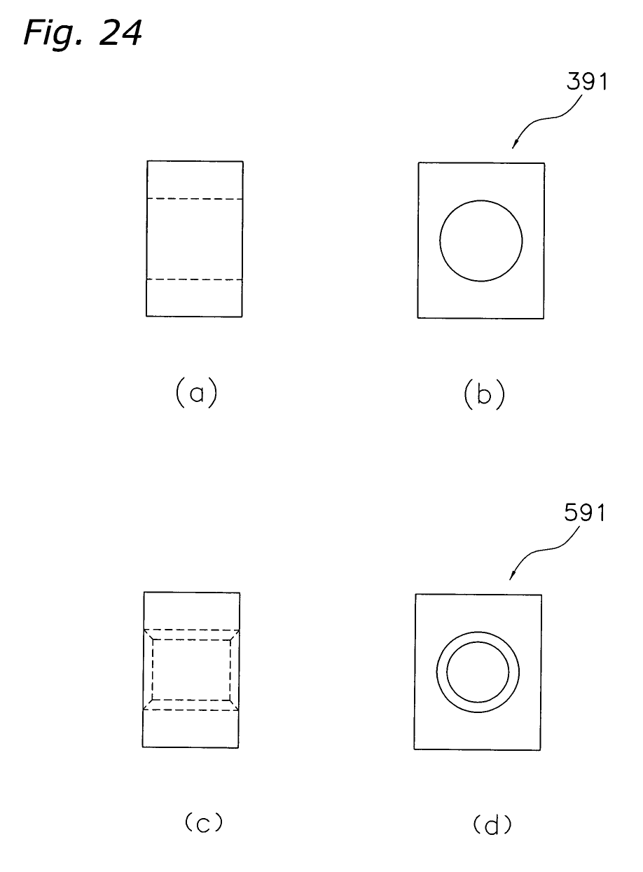

In the embodiments (fourth to sixth embodiments) already described, each of the trunk portions 367 and 567 of the first fixing units 361 and 561 has a substantially cylindrical form, and is provided with flat surfaces 367a and 367b, or 567a and 567b formed by partially flattening the outer peripheral surface of the cylindrical member. As shown in FIG. 24, however, each of first fixing members 391 and 591 may have a form prepared from a rectangular bar.

### INDUSTRIAL APPLICABILITY

The invention can be utilized in a multi-plate clutch device and a clutch disk assembly, and particularly to a multi-plate clutch device and a clutch disk assembly enhanced for high loads.

1. A multi-plate clutch device for transmitting and cutting off, with respect to an output rotor, power from an engine input rotor, the multi-plate clutch device comprising:
a clutch disk assembly being coupled to the output rotor and disposed near the input rotor; and
a clutch cover assembly being coupled to the input rotor and including a pressure plate to press the clutch disk assembly towards the input rotor, the clutch disk assembly having
a hub being coupled to the output rotor,
a friction coupler being disposed at an outer peripheral side of the hub and being nipped between the input rotor and the pressure plate, and
a damper mechanism elastically coupling the hub and the friction coupler in a rotation direction,
the friction coupler having
a ring member being coupled to an outer peripheral side of the damper mechanism,
a plurality of first friction plates being disposed at an outer peripheral side of the ring member and engaged with the ring member to be relatively unrotatable and to be relatively movable in an axial direction, and
a second friction plate being disposed between the plurality of first friction plates and being engaged with the clutch cover assembly to be relatively unrotatable and to be relatively movable in the axial direction,
at least one of the plurality of first friction plates being configured by a carbon composite material.

2. The multi-plate clutch device of claim 1, wherein at least any one of the input rotor, the pressure plate and the second friction plate is configured by a carbon composite material.

3. The multi-plate clutch device of claim 1, wherein
the hub includes a flange portion that projects outward in a radial direction around the entire periphery of the hub and a plurality of housing portions formed by part of the flange portion being cut out, and
the damper mechanism is disposed with a plurality of elastic members housed in the housing portions and a pair of coupler plates that are disposed so as to be relatively rotatable with respect to the flange portion in a state where the coupler plates nip the flange portion in the axial direction, with the coupler plates being disposed with window hole portions at positions corresponding to the elastic members.

4. The multi-plate clutch device of claim 1, wherein
the ring member includes a plurality of outer teeth formed around the entire outer peripheral side of the ring member and projects outward in the radial direction, and
the first friction plates include a plurality of inner teeth that is formed around the entire inner peripheral sides of the first friction plates and engages with the outer teeth.

5. The multi-plate clutch device of claim 4, wherein the ring member includes projecting portions that are disposed between the plurality of first friction plates and project further outward in the radial direction from the outer teeth.

6. The multi-plate clutch device of claim 1, wherein
the clutch cover assembly includes an annular clutch cover and cover members that are multiply disposed in the rotation direction and couple together the input rotor and the clutch cover, and
the second friction plate includes a plurality of notch portions that engage with the cover members.

7. The multi-plate clutch device of claim 3, further including fixing members that fix a part of the inner peripheral side of the ring member in a state where the part of the inner peripheral side of the ring member is nipped between the outer peripheral sides of the pair of coupler plates.

8. The multi-plate clutch device of claim 3, wherein
the ring member includes a plurality of first engagement portions that project inward in the radial direction, and
the flange portion includes second engagement portions that project outward in the radial direction and contact with the first engagement portions when the second engagement portions rotate a predetermined relative angle.

9. The multi-plate clutch device of claim 7, wherein each fixing member includes a body portion having a cylindrical shape, head portions that are disposed at both ends of the body portion and have a larger outer diameter dimension than that of the body portion, and a stepped portion that is disposed between the body portion and one of the head portions and has a larger outer diameter dimension than that of the body portion and a smaller outer diameter dimension than that of the head portion.

10. The multi-plate clutch device of claim 7, wherein each fixing member includes a body portion having a cylindrical shape, head portions that are disposed at both ends of the body portion and have a larger outer diameter dimension than that of the body portion, and a tapered portion that is disposed between the body portion and one of the head portions and has an outer diameter dimension that gradually becomes larger from the body portion towards the head portion.

11. The multi-plate clutch device of claim 1, wherein
at least one of the input rotor, the pressure plate and the second friction plate is made of a material containing iron as a main ingredient.

12. The multi-plate clutch device of claim 1, further comprising
a release device engaged with the first biasing member axially and elastically deforming the first biasing member, wherein
the release device axially moves towards the input rotor to release the biasing force applied by the first biasing member to the pressure plate.

13. The multi-plate clutch device of claim 1, further comprising
a release device engaged with the first biasing member axially and elastically deforming the first biasing member, wherein
the release device axially moves away from the input rotor to release the biasing force applied by the first biasing member to the pressure plate.

14. The multi-plate clutch device of claim 1, further comprising
a second biasing member located between said input and output rotors, and having an elastic reaction force smaller than a pushing load applied to said first friction plate for power transmission.

15. The multi-plate clutch device of claim 14, wherein
the second biasing member is arranged between the first biasing member and the pressure plate.

16. The multi-plate clutch device of claim 3, further comprising
an annular friction member arranged between at least one of the coupler plates and the flange portion to receive an axial load exerted between the coupler plate and the flange portion.

17. The multi-plate clutch device of claim 3, further comprising
an annular third biasing member arranged between at least one of the coupler plates and the flange portion to apply an axial biasing force between coupler plate and the flange portion.

18. The multi-plate clutch device of claim 17, wherein
the third biasing member is formed of an axially and elastically deformable Belleville spring.

19. The multi-plate clutch device of claim 17, wherein
the third biasing member is formed of an axially and elastically deformable wavy spring.

20. A clutch disk assembly for transmitting and intercepting a power from a flywheel on an engine side to an input shaft of a transmission, comprising:
a friction plate being made of carbon and pressed against the flywheel;
a clutch disk body having a disk-like input portion having an outer periphery portion coupled to an inner peripheral portion of the friction plate, and an output portion coupled to the input shaft of the transmission; and
a plurality of fixing units directly coupling the outer peripheral portion of the disk-like input portion to the inner peripheral portion of the friction plate.

21. The clutch disk assembly of claim 20, wherein
the friction plate has a recess for inserting said fixing unit, and
the fixing unit has
a flange portion being in contact with a side surface of the friction plate to restrict the relative axial movement of the friction plate,
a trunk portion inserted into the recess of the friction plate, having a thickness corresponding to the thickness of the friction plate and having an end surface partially in contact with a side surface of the disk-like input portion, and
a fixing portion formed at an end remote from the flange portion, and fixed to the disk-like input portion.

22. The clutch disk assembly of claim 20, wherein
the fixing unit is a rivet, and the fixing portion is fixed by caulking.

23. The clutch disk assembly of claim 20, wherein
the friction plate has a recess to accommodate the fixing unit, and
the fixing units are formed of
a first fixing unit having a trunk portion inserted into the recess of the friction plate,
a second fixing unit having a shaft portion axially extending through the first fixing unit,
a flange portion formed at one end of the shaft portion and axially engaging with the friction plate, and
a fixing portion formed at the other end of the shaft portion and axially engaging with the disk-like input portion.

24. The clutch disk assembly of claim 20, wherein
the friction plates are arranged in two positions on axially opposite sides of an outer peripheral portion of the disk-like input portion, respectively, and have recesses for inserting the fixing unit and
the fixing units are formed of
a first fixing unit having a trunk portion inserted into the recess of the friction plate, and
a second fixing unit having a shaft portion axially extending through the first fixing unit and the disk-like input portion,
a flange portion formed on one end of the shaft portion and axially engaging with one of the friction plates, and
a fixing portion formed on the other end of the shaft portion and axially engaging with the other friction plate.

25. The clutch disk assembly of claim 23, wherein
the second fixing unit is a rivet, and the fixing portion is fixed by caulking.

26. The clutch disk assembly of claim 20, wherein
the friction plate has a recess to accommodate the fixing unit, and
the fixing units are formed of a first fixing unit having a trunk portion inserted into the recess of the friction plate, having a thickness corresponding to the thickness of the friction plate and having an end surface partially in contact with a side surface of the disk-like input portion, and a fixing portion fixed to the disk-like input portion, and
a second fixing portion having a flange portion axially engaging with the friction plate, and a coupling portion coupling the flange portion and the first fixing unit together.

27. The clutch disk assembly of claim 20, wherein
the friction plate has a recess for inserting the fixing unit; and
the fixing units are formed of
a first fixing unit having a trunk portion inserted into the recess of the friction plate, and
a second fixing portion having a flange portion axially engaging with the friction plate, a coupling portion axially extending through the first fixing unit and fixing the flange portion to the first fixing unit, and
a fixing portion formed at an end of the coupling portion remote from the flange portion, and coupling said first fixing unit to the disk-like input portion.

28. The clutch disk assembly of claim 21, wherein
the trunk portion has an axial length equal to or longer than the thickness of the friction plate.

29. The clutch disk assembly of claim 21, wherein
the recess of the friction plate has a pair of parallel side surfaces extending in a radial direction, and
the trunk portion of the fixing unit has a pair of flat surfaces to contact with the pair of side surfaces.

30. The clutch disk assembly of claim 29, wherein
spaces are ensured between the pair of plat surfaces formed at the trunk portion of the fixing unit and the pair of side surfaces of the recesses of the friction plate.

31. The clutch disk assembly of claim 22, wherein
the fixing unit further has an annular member arranged between the friction plate and at least one of the flange portion and the fixing portion.

32. The clutch disk assembly of claim 31, wherein
the annular member has an outer diameter larger than the circumferential width of the recess of the friction plate.

33. The clutch disk assembly of claim 23, further comprising
an annular coupling member being configured to couple the plurality of fixing units, wherein
the coupling member is arranged between the friction plate and the flange portion.

34. The clutch disk assembly of claim 20, wherein
the clutch disk body includes
a hub serving as the output portion and having a boss coupled to the input shaft of the transmission and a flange portion extending radially from the boss, and
a disk-like input plate arranged on a side of the flange portion of the hub and serving as the disk-like input portion.

35. The clutch disk assembly of claim 34, wherein
the disk-like plate is arranged to rotate within a predetermined angular range with respect to the flange portion of the hub, and
the clutch disk body further includes a damper portion circumferentially and electrically coupling the disk-like input plate and the flange portion of the hub.
